(19) United States
(12) Patent Application Publication
(10) Pub. No.: US 2011/0171929 A1
(43) Pub. Date: Jul. 14, 2011

(54) WIRELESS COMMUNICATION BASE STATION, WIRELESS COMMUNICATION EQUIPMENT, AND WIRELESS COMMUNICATION SYSTEM

(75) Inventors: Takashi Tamura, Kanagawa (JP); Takahisa Aoyama, Kanagawa (JP); Jun Hirano, Kanagawa (JP); Chie Ishida, Kanagawa (JP)

(73) Assignee: PANASONIC CORPORATION, Osaka (JP)

(21) Appl. No.: 13/120,258

(22) PCT Filed: Sep. 18, 2009
(86) PCT No.: PCT/JP2009/004710

§ 371 Date: Mar. 22, 2011

(30) Foreign Application Priority Data
Sep. 22, 2008 (JP) 2008-242393

(51) Int. Cl. H04W 4/22

(52) U.S. Cl. 455/404.1

(57) ABSTRACT

A wireless communication base station (10) comprises a system information generating unit (20) that generates system information including a several system information messages, a paging message generating unit (22) that generates a paging message including a modification flag that indicates whether or not the system information has been modified; and a transmitter (18) that transmits the system information and the paging message. The system information generating unit (20) generates system information including a system information message in which an emergency message is described, and the paging message generating unit (22) generates a paging message that further includes information indicating that the emergency message is present in the system information and an identifier that identifies a system information message in which the emergency message is described. Consequently, a wireless communication base station can be provided which is capable of urgently notifying system information to be broadcast at a schedule according to the urgency of the system information while suppressing modifications to the system information as much as possible.

### RELATED APPLICATION

The present application is based upon and claims the benefit of priority from Japanese Patent Application No. 2008-242393, filed on Sep. 22, 2008, the disclosure of which is incorporated herein in its entirety by reference.

### TECHNICAL FIELD

The present invention relates to a wireless communication base station that urgently broadcasts system information to a wireless communication equipment, a wireless communication system, and the like.

### BACKGROUND ART

The standards body 3GPP (The 3rd Generation Partnership Project) is in the process of standardizing LTE (Long Term Evolution) as a next-generation W-CDMA (Wideband Code Division Multiple Access) communication standard.

In LTE, a base station (E-UTRAN NodeB, hereinafter referred to as “eNB”) of a network (E-UTRAN: Evolved Universal Mobile Radio Access Network) broadcasts system information to a equipment (for example, mobile terminal or user equipment, hereafter referred to as “UE”) existing in a cell (also referred to as an area) in order to control the UE. System information is important information that becomes an index for various operations of the UE and includes, for example, system bandwidth information, transmission antenna information, cell information (a cell identifier, cell access barring information, cell selection information, and cell re-selection information), scheduling information of system information messages, access class control information, and shared channel configuration.

FIG. 19 is a diagram illustrating a classification of system information. As illustrated in FIG. 19, system information is divided into a Master Information Block (hereinafter referred to as “MIB”) that is broadcast using a Broadcast Channel (BCH) and a number of System Information Blocks (hereinafter referred to as “SIB”) that is broadcast using a Downlink Shared CHannel (DL-SCH). SIBs are divided into types depending on contents of system information. Non Patent Literature 1 (TS.36.331 v8.2.0) specifies eight types of SIBs from SIB1 to SIB8. In addition, an alternative SIB (hereinafter, referred to as “SIB_spare”) is provided whose content is undetermined.

Such system information is broadcast to a UE in the form of a message (RRC message: Radio Resource Control message). Three types of messages (a Master Information Block Message (hereinafter referred to as “MIB Message”), a System Information Block Type1 Message or System Information Message 1 (hereinafter referred to as “SI-1”), and a normal System Information Message) are defined for system information according to the use.

With the MIB Message, the MIB includes parameters essential for a UE to receive other system information messages and the MIB Message is constituted by the MIB itself.

With the SI-1, since SIB1 includes scheduling information of system information messages other than SI-1 (a broadcast period of each system information message, a length of a time domain window of each system information message, a type of an SIB included in each system information message), a broadcast period is determined in advance and the SI-1 is constituted by the SIB1 itself.

With a normal system information message, each of SIB2 to SIB8 may be independently configured as a single system information message or, when the broadcast period is the same, a single system information message is made by several SIBs.

FIGS. 20A and 20B are diagrams illustrating the example of the information elements of system information and mapping examples between SIBs (SIB2 to SIB8) and system information message. As illustrated in FIG. 20A, a system information message constituted by SIB2 to SIB8 comprises an identifier indicating a type of SIB (sib-Type) and the SIB itself (sib-Info).

FIG. 20B illustrates a specific example of a system information message. System information message 2 (hereinafter referred to as “SI-2”) comprises sibType2 that indicates an SIB type and contents of SIB2. System information message 3 (hereinafter referred to as “SI-3”) comprises sibType3 that indicates an SIB type and contents of SIB3, and sibType4 that indicates an SIB type and contents of SIB4. System information message 4 (hereinafter referred to as “SI-4”) comprises sibType5 that indicates an SIB type and contents of SIB5, sibType6 that indicates an SIB type and contents of SIB6, and sibType7 that indicates an SIB type and contents of SIB7. System information message 5 (hereinafter referred to as “SI-5”) comprises sibType8 that indicates an SIB type and contents of SIB8. The configurations described above are examples and mapping of SIBs to a system information message can be modified.

When an eNB modifies a content of system information which is broadcasted to a UE in a cell, the content is not modified in the middle of a Modification Period. Information regarding a duration of the Modification Period is included in SIB2. When the eNB informs the UE of a modification of system information, the eNB broadcasts a Paging Message including a flag informing a modification of system information (hereinafter, also referred to as “SystemInfoModification”) to the UE by using a Paging Channel (PCH). Then, a UE can recognize the modification of system information. A Paging Message has several information elements that are an identifier of system information, a reason for paging (paging cause), and systemInfoModification. In case that a Paging message is used to page the UE, a Paging Message includes an identifier of the UE (UE-identity) and a reason for paging (paging cause). In case that an eNB informs a UE of modification of system information, a Paging Message includes systemInfoModification. In addition, when a Paging message is used for both paging a UE and informing a modification of system information, the Paging Message includes both information.

A temporary identifier referred to as S-TMSI (SAE (System Architecture Evolution) Temporary Mobile Station Identifier) that is assigned to each UE by a network or a fixed identifier of a UE referred to as IMSI (International Mobile Subscriber Identity) is entered in a UE-identity field. The S-TMSI and IMSI are used by the network to manage the UE. When a Paging Message address several UEs, the UE-identity field includes the S-TMSI or IMSI of all such UEs.

A paging cause is included in a Paging Cause field. Examples of entries include Terminating Conversational Call, Terminating Streaming Call, Terminating Interactive Call, Terminating Background Call, Terminating High Priority Signaling, Terminating Low Priority Signaling, and Terminating—cause unknown. Such causes are to be informed to each UE.

SystemInfoModification is used by an eNB to inform a UE of a modification of system information to be broadcast to the UE, and when system information is modified, a modification flag (SystemInfoModification) (on) is included in a Paging Message.

FIG. 21 is an explanatory diagram of a notification of system information modification by an eNB to a UE. FIG. 21 illustrates an example of a modification to SI-3. When modifying a content of system information, the eNB broadcasts a Paging Message including a modification flag (SystemInfoModification) (on) to the UE from the start of a next Modification Period. Upon receiving the Paging Message, when the UE determines that a modification flag (SystemInfoModification) (on) is included in the Paging Message, the UE performs a procedure for receiving system information (hereinafter referred to as “System information acquisition”) during a next Modification Period.

In LTE, as modes of UEs, there are a UE in an idle mode (RRC-IDLE) and a UE in a connected mode (RRC_CONNECTED). Since types of SIBs required by a UE in an idle and a UE in a connected mode differ from each other, types of SIBs to be received in System information acquisition by UEs in the respective modes are specified.

FIG. 22 is an explanatory diagram of System information acquisition. As illustrated in FIG. 22, an eNB broadcasts an MIB Message, SI-1, and other system information messages. A UE receives a system information message necessary for the UE based on the MIB Message as well as the SI-1 including scheduling information of other system information messages.

A procedure of receiving a system information message when a UE initially connects to an eNB will be described. When a UE connects to an eNB, the UE synchronizes with the eNB. Since schedule of the MIB Message and SI-1 are specified in advance, the UE receives the MIB Message and SI-1 according to the schedule specified in advance. In addition since SI-1 includes scheduling information of other system information messages, the UE is able to receive scheduling information of a necessary system information message. After receiving SIB2, the UE is able to receive a Paging Message based on scheduling information (broadcast period or the like) of the Paging Message included in SIB2.

Using the techniques described above, the UE is capable of receiving an MIB, an SIB1, and necessary SIBs among system information broadcast by the eNB.

### CITATION LIST

### Non Patent Literature

Non Patent Literature 1: 3GPP TS36.331 v8.2.0 “Evolved Universal Terrestrial Radio Access (E-UTRA) Radio Resource Control (RRC)”
Non Patent Literature 2: 3GPP TS22.168 v9.0.0 “Earthquake and Tsunami Warning System (ETWS) requirements”
Non Patent Literature 3: 3GPP TSG RAN WG2 meeting #63 R2-084064, “Considerations on ETWS mechanisms”, Qualcomm Europe.
Non Patent Literature 4: 3GPP TS34.123-1 v8.3.0 “User Equipment (UE) conformance specification; Part 1: Protocol conformance specification”

### SUMMARY OF INVENTION

### Technical Problem

Recently, there have been demands for an Earthquake and Tsunami Warning System (hereinafter referred to as “ETWS”) that notifies a UE of an occurrence of a disaster (for example, refer to Non Patent Literature 2). The ETWS broadcasts an initial report (hereinafter referred to as “Primary Notification”) that notifies an occurrence of around 100 types of disasters including earthquakes and tsunamis and a second report (hereinafter referred to as “Secondary Notification”) that notifies detailed information on the disaster. An eNB is required to deliver a Primary Notification to a UE within four seconds of receiving the Primary Notification. The emergency notification of the Primary Notification to the UE is conceivably broadcast as system information. Even in cases other than such emergency notifications of a disaster, finer access control of a UE can conceivably be performed by also modifying, within a Modification period, system information such as emergency access class control due to increasing the traffic suddenly in a cell.

However, with the method described in Background Art in which system information broadcast by an eNB is not modified in the middle of a Modification Period, system information cannot be modified in case of an emergency. Non Patent Literature 3 proposes a method of modifying system information in the middle of a Modification Period.

According to Non Patent Literature 3, an eNB prepares a system information message for delivering a system information block for Primary Notification and a system information message for delivering a system information block for Secondary Notification, and respective scheduling information thereof is always included in SI-1 and broadcast to a UE. In addition, SI-1 has a flag for ETWS system information messages (to be shared by Primary Notification and Secondary Notification).

At normal times, since the eNB does not transmit an ETWS system information message, by turning off the flag for an ETWS system information message described in SI-1, a period for transmitting an ETWS system information message is not provided and scheduling for other system information messages is being carried out. On the other hand, during an emergency, when the eNB turns on the flag for an ETWS system information message in a Paging Message and notifies the Paging Message to a UE, the UE turns on the flag of the ETWS system information message which is stored in a previously received SI-1. And the UE switches scheduling information which provides a period for transmitting an ETWS system information message, and receives the ETWS system information message.

However, with this method, since scheduling of emergency system information messages is performed in advance, the eNB includes scheduling information for ETWS system information that are normally unused in SI-1. Therefore, the number of bits in SIB1 to be transmitted increases and causes problems such as needless consumption of radio resources (frequency resources) and needless consumption of power at wireless eNBs and UEs.

In addition, since the ETWS supports the occurrences of around 100 types of disasters, depending on the disaster, system information to be urgently modified conceivably includes those with a high degree of urgency as well as those less urgent. With the method described above, since system information messages are broadcast according to the same schedule despite differences in the urgency of ETWS system information, problems arise in that notification cannot be performed in a short period in case of a high degree of urgency or that notification is inadvertently performed in a short period even in less urgent cases, thereby affecting broadcast of existing system information messages. Consequently, a problem arises in that radio resources (frequency resources) are needlessly consumed and power at wireless base stations is needlessly consumed.

The present invention has been made in consideration of the background described above and an object thereof is to provide, in a method where an eNB urgently broadcasts system information to a UE, a wireless communication base station and a wireless communication equipment that enable an urgent notification to be performed according to a schedule that takes urgency of system information to be broadcast into consideration while suppressing, as much as possible, modifications to the system information.

### Solution to Problem

A wireless communication base station according to the present invention is a wireless communication base station that controls a wireless communication equipment using system information, the wireless communication base station comprising: a system information generating unit that generates system information which includes several system information messages and in which one system information message among the several system information messages includes a schedule of another system information message; a paging message generating unit that generates a paging message including a modification flag that indicates whether or not the system information has been modified; and a transmitter that transmits the system information generated by the system information generating unit and the paging message generated by the paging message generating unit, wherein the system information generating unit generates system information including a system information message in which an emergency message is described, and the paging message generating unit generates a paging message that further includes information indicating that the emergency message is present in the system information and an identifier that identifies a system information message in which the emergency message is described.

In this manner, since the presence of an emergency message as well as an identifier of a system information message in which the emergency message is described are broadcast by using a paging message, a wireless communication equipment having received the paging message needs only to receive the system information message identified by the identifier. Therefore, an emergency message can be promptly received unlike in a case of a modification of normal system information where all system information messages assumed to be necessary according to a state of a wireless communication equipment are received after receiving a schedule.

A wireless communication equipment according to the present invention is a wireless communication equipment that is controlled by system information transmitted from a wireless communication base station, the wireless communication equipment comprising: a receiver that receives system information which includes a several system information messages and in which one system information message among the several system information messages has a schedule of another system information message and that receives a paging message that includes an emergency flag that indicates whether or not an emergency message is present and, when the emergency message is present, an identifier that identifies a system information message in which the emergency message is described; a paging managing unit that analyzes the paging message received by the receiver; and a controller that obtains, when the paging managing unit determines that an emergency message is present, a broadcast timing of the system information message identified by the identifier included in the paging message based on the schedule, and that indicates the receiver to receive the system information message at the broadcast timing.

In this manner, the wireless communication equipment receives a paging message including an emergency flag and an identifier of a system information message in which an emergency message is described, and receives the system information message identified by the identifier based on a schedule. Therefore, an emergency message can be promptly received unlike in a case of a modification of normal system information where all system information messages assumed to be necessary according to a state of a wireless communication equipment are received after receiving a schedule.

A wireless communication system according to the present invention is a wireless communication system in which a wireless communication base station and a wireless communication equipment are connected, wherein the wireless communication base station comprises: a system information generating unit that generates system information which includes several system information messages and in which one system information message among the several system information messages includes a schedule of another system information message; a paging message generating unit that generates a paging message including a modification flag that indicates whether or not the system information has been modified; and a transmitter that transmits the system information generated by the system information generating unit and the paging message generated by the paging message generating unit, the system information generating unit adapted to generate system information including a system information message in which an emergency message is described, and the paging message generating unit adapted to generate a paging message that further includes information indicating that the emergency message is present in the system information and an identifier that identifies a system information message in which the emergency message is described, the wireless communication equipment comprises: a receiver that receives the system information and the paging message; a paging managing unit that analyzes the paging message received by the receiver; and a controller that obtains, when the paging managing unit determines that an emergency message is present, a broadcast timing of the system information message identified by the identifier included in the paging message based on the schedule, and that indicates the receiver to receive the system information message at the broadcast timing.

According to this configuration, an emergency message can be promptly notified from a wireless communication base station to a wireless communication equipment in the same manner as the wireless communication base station and the wireless communication equipment according to the present invention described earlier.

An emergency message notification method according to the present invention is a method in which a wireless communication base station notifies a wireless communication equipment of an emergency message, the emergency message notification method comprising the steps of: generating system information which includes a several system information messages and in which one system information message among the several system information messages includes a schedule of another system information message; the wireless communication base station generating a paging message including a modification flag that indicates whether or not the system information has been modified; the wireless communication base station transmitting the system information; and the wireless communication base station transmitting the paging message, wherein in the step of generating system information, system information is generated which includes a system information message in which an emergency message is described, and in the step of generating a paging message, a paging message is generated that further includes information indicating that the emergency message is present in the system information and an identifier that identifies a system information message in which the emergency message is described.

An emergency message reception method according to the present invention is a method in which a wireless communication equipment receives an emergency message transmitted from a wireless communication base station, the emergency message reception method comprising the steps of: the wireless communication equipment receiving system information which includes a several system information messages and in which one system information message among the several system information messages includes a schedule of another system information message; the wireless communication equipment receiving a paging message that includes an emergency flag that indicates whether or not an emergency message is present and, when the emergency message is present, an identifier that identifies a system information message in which the emergency message is described; the wireless communication equipment analyzing the received paging message; and when it is determined based on the paging message that an emergency message is included in the system information, the wireless communication equipment obtaining a broadcast timing of the system information message identified by the identifier included in the paging message based on the schedule, and controlling so as to receive the system information message at the broadcast timing.

### Advantageous Effects of Invention

According to the present invention, since the presence of an emergency message as well as an identifier of a system information message in which the emergency message is described are broadcast using a paging message, a wireless communication equipment having received the paging message need only receive the system information message identified by the identifier, and an advantage can be gained in that an emergency message can be promptly received.

As will be described below, there are other aspects of the present invention. Therefore, the disclosure of the present invention is intended to provide a part of the present invention and is not intended to limit the scope of the invention as described and claimed herein.

### BRIEF DESCRIPTION OF DRAWINGS

FIG. 1 is a diagram illustrating a configuration of a base station according to a first embodiment.

FIG. 2 is a diagram illustrating a configuration of a UE according to the first embodiment.

FIG. 3 is a diagram illustrating a positional relationship between a base station and a UE.

FIG. 4A is an explanatory diagram of a configuration example of an emergency system information message.

FIG. 4B is an explanatory diagram of another configuration example of an emergency system information message.

FIG. 4C is an explanatory diagram of yet another configuration example of an emergency system information message.

FIG. 5A is a diagram illustrating an example of a normal-time paging message.

FIG. 5B is a diagram illustrating an example of a paging message upon message modification.

FIG. 5C is a diagram illustrating an example of an emergency paging message.

FIG. 5D is a diagram illustrating an example of a normal-time paging message.

FIG. 5E is a diagram illustrating an example of a paging message upon message modification.

FIG. 5F is a diagram illustrating an example of an emergency paging message.

FIG. 6A is an explanatory diagram of transmission timings of a paging message and a system information message to be broadcast during normal time from a base station to a UE.

FIG. 6B is an explanatory diagram of transmission timings of a paging message and a system information message to be broadcast during an emergency from a base station to a UE.

FIG. 7 is an explanatory diagram illustrating another example of transmission timings of a paging message and a system information message to be broadcast during an emergency from a base station to a UE.

FIG. 8 is a diagram illustrating operations of a base station according to the first embodiment.

FIG. 9 is a diagram illustrating another example of a broadcast timing of an emergency message.

FIG. 10 is a diagram illustrating yet another example of a broadcast timing of an emergency message.

FIG. 11 is a diagram illustrating operations of a UE according to the first embodiment.

FIG. 12 is a diagram illustrating a configuration of a base station according to a second embodiment.

FIG. 13 is a diagram illustrating a configuration of a UE according to the second embodiment.

FIG. 14A is a diagram illustrating an example of an emergency paging message according to the second embodiment.

FIG. 14B is a diagram illustrating another example of an emergency paging message.

FIG. 15 is an explanatory diagram illustrating transmission timings of a paging message and a system information message to be broadcast during an emergency from a base station to a UE.

FIG. 16 is an explanatory diagram illustrating another example of transmission timings of a paging message and a system information message to be broadcast during an emergency from a base station to a UE.

FIG. 17 is a diagram illustrating operations of a base station according to the second embodiment.

FIG. 18 is a diagram illustrating operations of a UE according to the second embodiment.

FIG. 19 is a diagram illustrating a classification of system information.

FIG. 20A is a diagram illustrating a configuration example of a system information message constituted by SIB2 to SIB8.

FIG. 20B is a diagram illustrating a specific example of a system information message constituted by SIB2 to SIB8.

FIG. 21 is an explanatory diagram of a notification of system information modification by an eNE to a UE.

FIG. 22 is an explanatory diagram of System information acquisition.

### DESCRIPTION OF EMBODIMENTS

Hereinafter, a detailed description of the present invention will be given. It is to be understood that the embodiments described below are illustrative only and various modifications can be made to the present invention. As such, the specific components and functions to be disclosed below are not intended to limit the scope of the present invention in any way.

Hereinafter, a wireless communication base station and a wireless communication equipment according to embodiments of the present invention will be described in detail with reference to the drawings. A description will now be given using, as an example, a wireless communication system comprising a wireless communication base station (hereinafter, referred to as a “base station”) and a wireless communication equipment (hereinafter, referred to as a “UE”). It is assumed that a single base station constitutes a single cell (also referred to as “area”). Moreover, in the embodiments below, components having like functions will be denoted by like reference characters and redundant descriptions thereof will be omitted.

The respective embodiments below will be described based on Long Term Evolution (LTE) and System Architecture Evolution (SAE) that are mobile communication technology standardized by 3GPP. However, in addition to the above standards specified by 3GPP, the present invention is applicable to a Wireless Local Area Network, WiMAX (Worldwide Interoperability for MicrowaveAccess) such as IEEE802.16, IEEE802.16e, and IEEE802.16m, 3GPP2, or wireless access technology such as fourth generation mobile telecommunication technology.

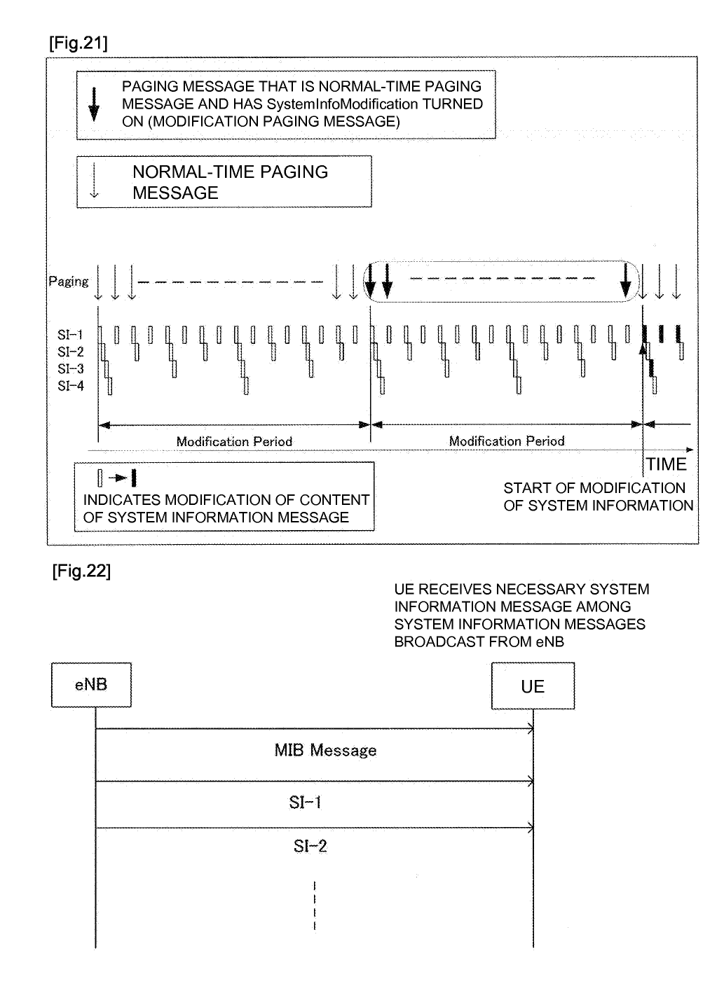

Before describing embodiments of the present invention, information that must be urgently broadcast to a UE 30 according to the present embodiment will be described. Information that must be urgently broadcast to a UE 30 refers to information that must be delivered as soon as possible to a user of the UE 30 such as ETWS described earlier. As already described with reference to FIG. 21, the LTE standard does not allow system information to be immediately modified whenever a need for such modification arises. In other words, system information can only be modified by notifying a modification of system information during a next Modification Period using a paging message and by transmitting the modified system information during a further next Modification Period. Since a typical Modification Period conceivably lasts for 10 seconds, it takes 10 seconds or more to transmit new system information to a UE and modify system information. Information requiring an urgent broadcast is information that cannot wait for a modification to occur during such Modification Periods. Moreover, such emergency notifications are to include information that a base station 10 itself has determined should be urgently transmitted in addition to messages notified from a network such as ETWS.

### First Embodiment

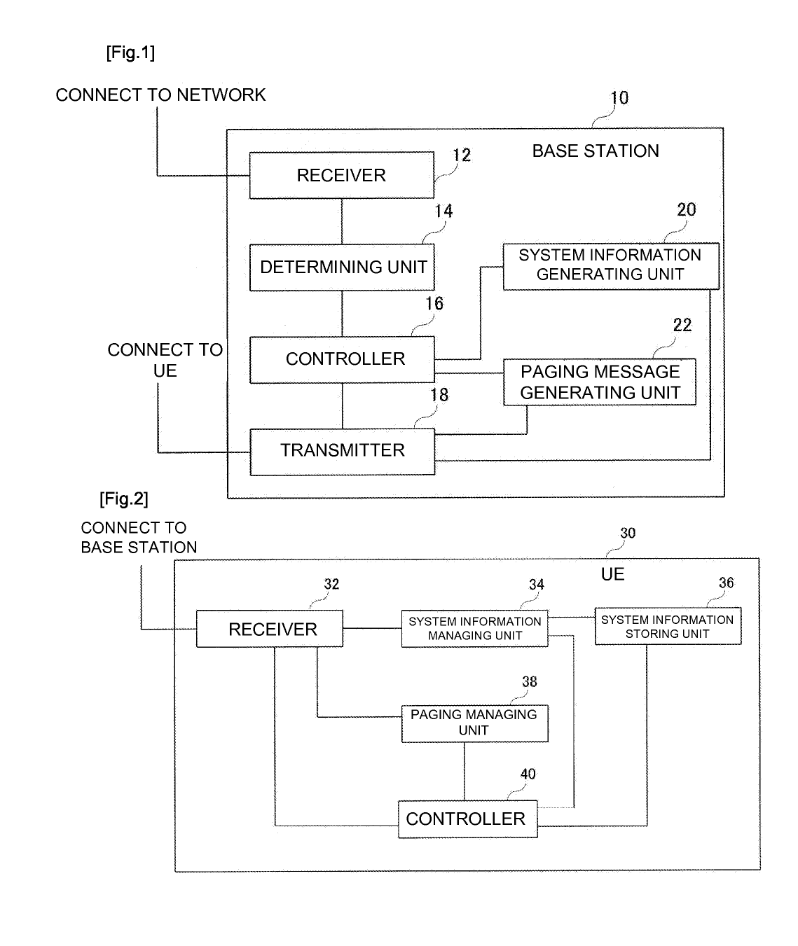

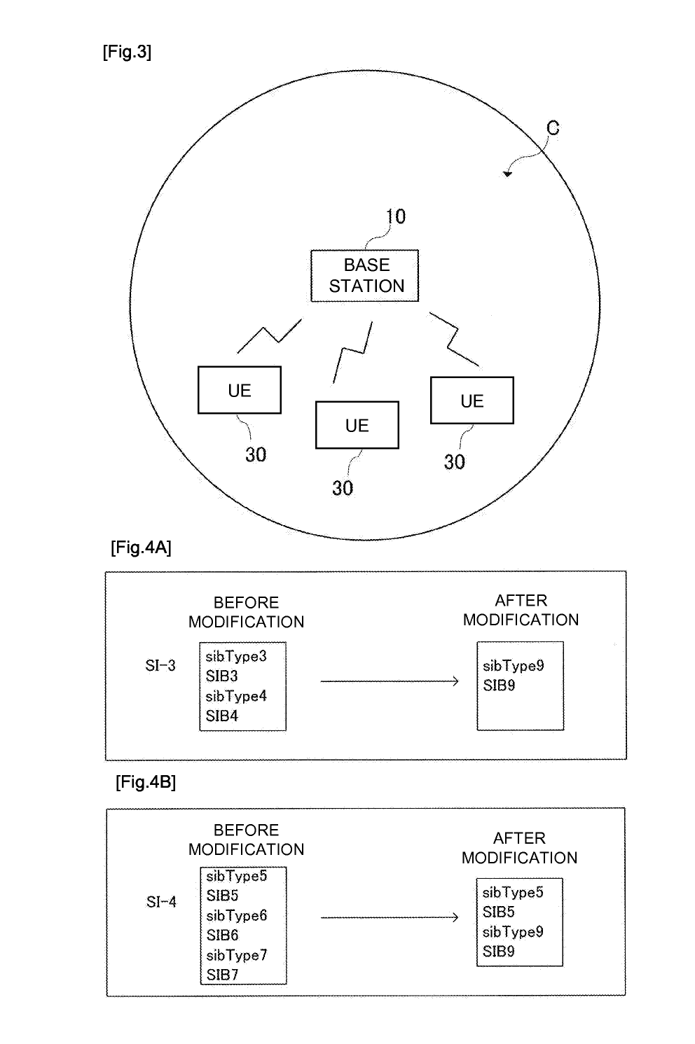

FIG. 1 is a diagram illustrating a configuration of a base station according to the present embodiment. FIG. 2 is a diagram illustrating a configuration of a UE according to the present embodiment. FIG. 3 is an explanatory diagram illustrating a positional relationship between the base station and the UE according to the present embodiment. As illustrated in FIG. 3, several UEs 30 is positioned in a cell C of the base station 10. The base station 10 allocates and manages radio resources (for example, frequency ranges, and frequency bands in a time domain) and assumes a role of an access point in a radio access network for the UEs 30. The UEs 30 receive signals transmitted from the base station 10 via a downlink.

### [Base Station]

A configuration of the base station 10 will be described with reference to FIG. 1. The base station 10 comprises a receiver 12, a determining unit 14, a controller 16, a transmitter 18, a system information generating unit 20, and a paging message generating unit 22.

The transmitter 18 transmits a paging message, a system information message, or the like to the UE 30 based on scheduling information sent from the controller 16.

The receiver 12 receives a paging message, an ETWS message, system information, and the like sent from the network (for example, an MME: Mobility Management Entity) and outputs the same to the determining unit 14.

The determining unit 14 analyzes the paging message, the ETWS message, the system information, and the like inputted from the receiver 12, and in the case of the ETWS message or the like that must be urgently broadcast to the UE 30, the determining unit 14 determines an urgency of system information thereof. In addition, when there is system information that the base station 10 itself has determined should be urgently broadcast (for example, access class control) besides information inputted from the receiver 12, the determining unit 14 determines an urgency of such system information. When an urgency is determined, the determining unit 14 outputs a determination result of urgency and emergency system information to the controller 16. When an urgency is not determined, the determining unit 14 outputs the inputted information as-is to the controller 16.

When emergency system information and a determination result of urgency thereof are inputted, the controller 16 determines a broadcast period of an emergency system information message based on the urgency information and scheduling information of system information messages currently being broadcast. For example, system information with a high degree of urgency is given the same period as a system information message with a short broadcast period among system information messages currently being broadcast. In other words, a broadcast timing is conformed to a system information message with a short broadcast period. In doing so, an identifier of the system information message may be conformed to an identifier of a system information message currently being broadcast. In this case, an identifier of a system information message refers to a numeral added to the end of SI such as “1” in the case of SI-1, “2” in the case of SI-2, “3” in the case of SI-3, and so on.

System information with a low degree of urgency may be broadcast at a broadcast timing at which a currently broadcast system information message is not broadcast, and a method may be stored in which the UE 30 can predict a broadcast period and a broadcast timing in advance. For example, system information with a low degree of urgency is to be given the same broadcast period as a system information message with the longest broadcast period among currently broadcast system information messages, and a broadcast timing is set to immediately after the system information message with the longest broadcast period is sent. As an identifier of a system information message, an identifier may be adopted which is obtained by adding 1 to the identifier of the system information message with the longest broadcast period among currently broadcast system information messages or, in other words, an identifier obtained by adding 1 to the largest identifier. In this case, UEs that do not support a broadcast of an emergency system information message remain unaware that an emergency system information message is being broadcast and are therefore unaffected.

As described above, depending on the urgency of system information, the base station 10 is capable of selecting an appropriate broadcast period from broadcast periods of system information messages that are currently being broadcast or other broadcast periods notified to the UE 30 in advance. Moreover, if a function is provided which causes a broadcast period of an emergency system information message to be included in a paging message, broadcast periods need not be notified to the UE 30 in advance.

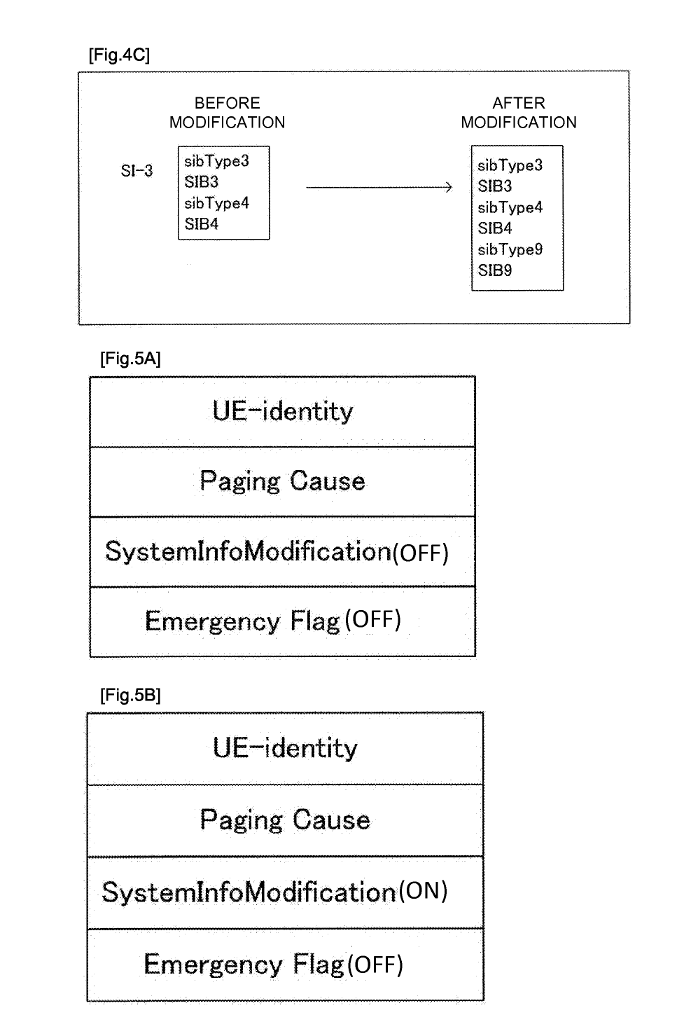

In addition, the controller 16 determines a configuration of a system information message. FIGS. 4A to 4C are explanatory diagrams of configuration examples of an emergency system information message. FIGS. 4A to 4C illustrate examples that use SIB9 as an emergency SIB.

When using the same identifier as a currently broadcast system information message, as illustrated in FIG. 4A, for example, the system information message may be entirely overwritten as in a case where SI-3, constituted by SIB3 and SIB4, is caused to be constituted only by SIB9 to be newly transmitted. In addition, as illustrated in FIG. 4B, for example, the system information message may be partially overwritten as in a case where SI-4, constituted by SIB5, SIB6, and SIB7, is caused to be constituted by SIB5 and SIB9. As far as specific examples are concerned, a case is conceivable in which SIB6 and SIB7 are not important but SIB5 is important and is therefore sent together with SIB9 to be newly transmitted. Furthermore, as illustrated in FIG. 4C, the system information message may be supplemented as in a case where SI-3, constituted by SIB3 and SIB4, is caused to be constituted by SIB3 and SIB4, and SIB9 to be newly transmitted. In this manner, a system information message can be generated according to a length of a time domain window. When a time domain window has sufficient length, an emergency system information can be included in existing system information message so that it can be transmitted in a short period without affecting broadcast of conventional system information messages. Furthermore, in a case where a UE that does not support emergency system information messages is provided with a function for discarding an SIB not supported by the UE, an emergency system information message can be sent without affecting broadcast of conventional system information messages whatsoever. Moreover, when the same identifier as a currently broadcast system information message is not used, a system information message can be newly generated.

In addition, the controller 16 indicates a configuration of a system information message, a content of the system information message, an identifier of the system information message, and a broadcast timing to the system information generating unit 20. Upon determining a configuration of an emergency system information message, a UE 30 to receive the broadcast, and a broadcast timing, the controller 16 determines a broadcast timing of a paging message.

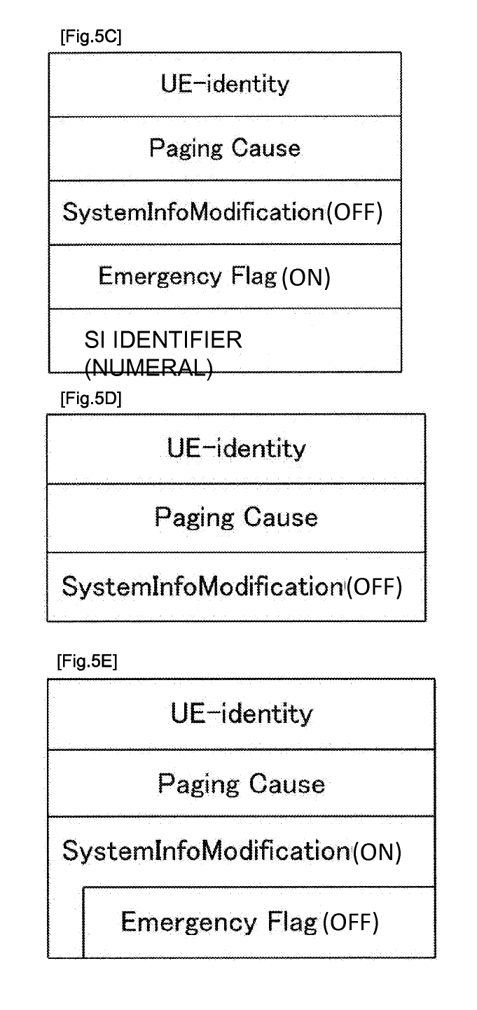

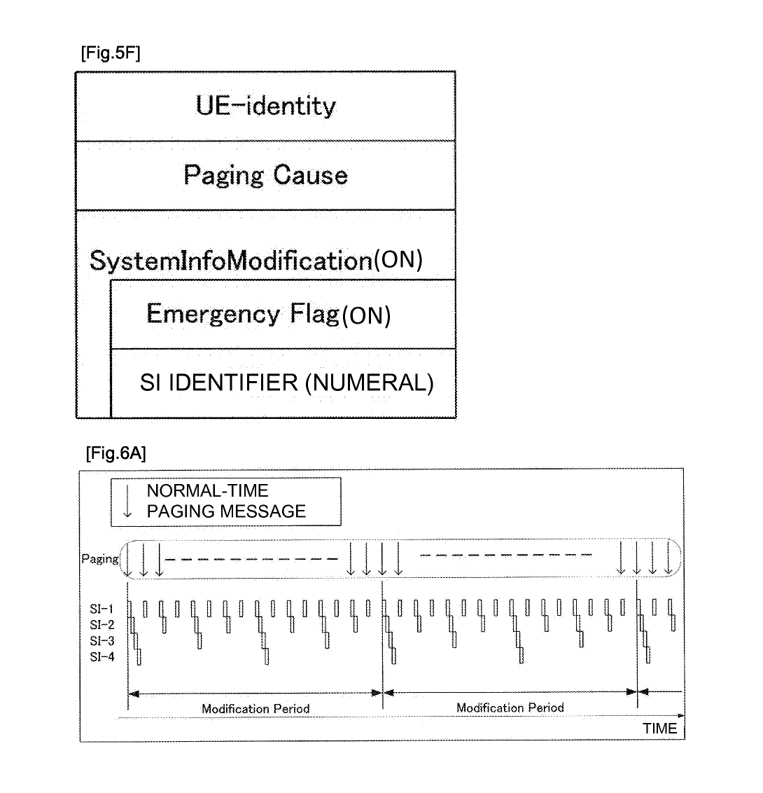

FIGS. 5A to 5C are diagrams illustrating examples of a paging message according to the present embodiment. FIG. 5A illustrates a paging message during normal time. Hereinafter, this paging message will also be referred to as a “normal-time paging message”. A normal-time paging message includes an identifier of a UE that is a paging object (UE-identity), a reason of paging (Paging Cause) such as arrival of an e-mail or an arrival of a call, a modification flag (SystemInfoModification) of a system information message, and an Emergency Flag that indicates the presence of a system information message to be urgently broadcast. During normal times, the modification flag and the Emergency Flag are turned off. Moreover, the UE-identity field and the Paging Cause field are not required fields and there may be cases where the fields are not provided.

FIG. 5B illustrates a paging message during modification of normal system information. Hereinafter, this paging message will also be referred to as a “modification paging message”. In this case, the modification paging message includes an identifier of the UE 30, a Paging Cause, and a modification flag (on) and an Emergency Flag (off). Since the modification flag is turned on, the UE 30 having received the modification paging message can be informed that system information has been modified, and since the Emergency Flag is turned off, the UE 30 can be informed that the message is not an emergency message.

FIG. 5C illustrates a paging message when an emergency message is to be notified. Hereinafter, this paging message will also be referred to as an “emergency paging message”. An emergency paging message includes an Emergency Flag (on) and an SI identifier. An SI identifier is information that identifies SI in which an emergency message has been written. Hereinafter, SI in which an emergency message has been written will also be referred to as an “emergency system information message”. The UE 30 having received an emergency paging message can be informed that an emergency message is present because the Emergency Flag is turned on. In addition, the UE 30 can receive an emergency message by determining at what timing an SI message identified by an SI identifier is transmitted based on a schedule that is broadcast in advance.

When a paging message is inputted from the network, the controller 16 outputs, to the paging message generating unit 22, the inputted paging message, a broadcast timing of the paging message, information necessary for generating a paging message (UE-identity, Paging Cause, and the like), information on whether or not an emergency system information message is present, and an identifier of the system information message in which the emergency message is described. When a paging message is not inputted, the controller 16 outputs, to the paging message generating unit 22, a broadcast timing of the paging message, information necessary for generating a paging message, information on whether or not an emergency system information message is present, and an identifier of the system information message.

Moreover, while information regarding a system information message is individually outputted from the controller 16 to the system information generating unit 20 and the paging message generating unit 22 in FIG. 1, an identifier of the system information message may alternatively be outputted from the system information generating unit 20 to the paging message generating unit 22. In addition, the controller 16 outputs, to the transmitter 18, an identifier of a system information message, scheduling information (for example, a broadcast period, a length of a time domain window, or a broadcast timing) of the system information message, and scheduling information of a paging message.

Furthermore, when a modification of normal system information is notified from the network or when the base station 10 determines that a modification of normal system information is necessary, the controller 16 determines a configuration and a schedule of a system information message and outputs, to the system information generating unit 20, a configuration of a system information message, constituent system information, an identifier of the system information message, and a broadcast timing. In addition, when a paging message is inputted in order to notify the UE 30 using the paging message of a modification of a system information message to be broadcast, the controller 16 notifies the modification of the system information message to the paging message generating unit 22 and outputs the inputted paging message, a broadcast timing thereof, and information necessary for generating a paging message. When a paging message is not inputted, the controller 16 notifies the paging message generating unit 22 of a modification of a system information message and outputs a broadcast timing of the system information message and information necessary for generating a paging message. Subsequently, the controller 16 outputs scheduling information of system information messages and the paging message to the transmitter 18.

When a paging message is inputted but no modification is made to a system information message, the controller 16 determines a schedule of the paging message and outputs the inputted paging message and scheduling information thereof to the transmitter 18.

Moreover, when a paging message is inputted to the paging message generating unit 22 and information for generating a paging message is unnecessary, information for generating a paging message need not be inputted to the paging message generating unit 22.

The system information generating unit 20 generates a system information message based on system information constituting the system information message and an identifier of the system information message, and outputs the system information message to the transmitter 18 based on inputted information (broadcast timing of the system information message and the like).

When a paging message and an identifier of an emergency system information message are inputted, the paging message generating unit 22 modifies the paging message based on the inputted paging message, the identifier of the emergency system information message, and information necessary for generating the paging message. For example, an identifier of a system information message in which an emergency message is described in system information is added to the inputted paging message. Subsequently, the paging message generating unit 22 outputs the modified paging message to the transmitter 18 based on the inputted broadcast timing information.

Furthermore, when a paging message is not inputted and an identifier of an emergency system information message is inputted, the paging message generating unit 22 generates a paging message in which an identifier of a system information message in which an emergency message is described is added to a normal-time paging message (including a UE-identity, a Paging Cause, and the like) based on the inputted identifier of the emergency system information message, information necessary for generating a paging message, and the like, and outputs the generated paging message to the transmitter 18 according to an inputted broadcast timing.

In addition, when a paging message and a modification to a normal system information message are inputted, the paging message generating unit 22 makes a modification to a paging message including a modification flag (SystemInfoModification) (on) based on the inputted paging message and information necessary for generating a paging message, and outputs the modified paging message to the transmitter 18 according to a broadcast timing. Furthermore, when a paging message is not inputted but a modification to a normal system information message is inputted, the paging message generating unit 22 generates a paging message including a modification flag (SystemInfoModification) (on) based the information necessary for generating a paging message, and outputs the generated paging message to the transmitter 18 according to an inputted broadcast timing.

Moreover, when a paging message is inputted to the paging message generating unit 22 but information necessary for generating a paging message is not, the paging message is to be modified without the information.

### [UE]

Next, a configuration of the UE 30 according to the present embodiment will be described with reference to FIG. 2. The UE 30 comprises a receiver 32, a system information managing unit 34, a system information storing unit 36, a paging managing unit 38, and a controller 40.

The receiver 32 receives a paging message and a system information message that are broadcast from the base station 10 based on scheduling information (for example, a broadcast period, a length of a time domain window, or a broadcast timing) of a paging message and a system information message inputted from the controller 40.

Moreover, after synchronizing with the base station 10, the UE 30 receives an MIB message and SI-1 whose broadcast timings are specified in advance. Since SI-1 includes scheduling information of other system information messages, the UE 30 is able to receive a necessary system information message. At this point, since scheduling information of transmission of paging messages is included in SIB2, the UE 30 can acquire scheduling information of paging messages and system information messages.

The system information managing unit 34 analyzes a system information message inputted from the receiver 32 and outputs system information to the system information storing unit 36. In addition, the system information managing unit 34 performs processing based on system information stored in the system information storing unit 36. For example, when it is determined that the validity of system information has expired and that system information needs to be updated, the system information managing unit 34 indicates the controller 40 to receive the system information. Moreover, when there is a request from the controller 40 for acquiring system information stored in the system information storing unit 36, the system information managing unit 34 may acquire the system information from the system information storing unit 36 and output the system information to the controller 40. Furthermore, the system information managing unit 34 may be provided with a function where, when there is a request from the controller 40 for discarding system information stored in the system information storing unit 36, the system information managing unit 34 discards the system information from the system information storing unit 36.

The system information storing unit 36 is constituted by a memory or the like, and stores system information inputted from the system information managing unit 34 and outputs necessary information to the system information managing unit 34 or the controller 40.

The paging managing unit 38 analyzes a paging message inputted from the receiver 32. When an Emergency Flag in the paging message has been turned on, the paging managing unit 38 outputs an identifier of an emergency system information message to the controller 40 and indicates the controller 40 to receive the emergency system information message. In addition, when a modification flag in the paging message has been turned on, the paging managing unit 38 notifies the controller 40 of the modification.

The controller 40 outputs, to the receiver 32, scheduling information (for example, a broadcast period, a length of a time domain window, or a broadcast timing) of a paging message or a system information message that needs to be received based on contents of an indication from the paging managing unit 38 or the system information managing unit 34, and indicates the receiver 32 to receive the message. At this point, if information in the system information storing unit 36 is required, the controller 40 makes a request for necessary information to the system information managing unit 34 or the system information storing unit 36 and acquires the necessary information. For example, the controller 40 acquires information such as information regarding a value_tag that indicates an update of system information or scheduling information. In addition, when it is determined that system information must be discarded, the controller 40 indicates the system information managing unit 34 or the system information storing unit 36 to discard the system information.

A method in which the base station 10 urgently broadcasts system information to the UE 30 in the wireless communication system comprising the base station 10 and the UE 30 respectively configured as described above will now be described with reference to FIGS. 6 to 11. First, an outline will be described with reference to FIGS. 6A and 6B.

FIGS. 6A and 6B are explanatory diagrams of transmission timings of a paging message and a system information message to be broadcast from the base station 10 to the UE 30 according to the present embodiment. FIG. 6A illustrates broadcast timings in a case of normal time where an emergency message is not present, and FIG. 6B illustrates broadcast timings in a case where an emergency message is present.

When there is a system information message to be urgently broadcast, the base station 10 broadcasts a paging message (emergency paging message) that includes, in addition to contents of a normal-time paging message, an identifier of a system information message in which a message to be urgently broadcast is described to the UE 30. This example shows that, in the emergency paging message, an emergency message is included in SI-2. In the example illustrated in FIG. 6B, the base station 10 starts broadcasting the emergency paging message at time t1.

The base station 10 broadcasts the emergency paging message and, at the same time, broadcasts a system information message including the emergency message. In the example illustrated in FIG. 6B, system information including the emergency message is broadcast from time t2. In FIG. 6B, SI-2 broadcast after time t2 is blacked out in order to indicate that contents of SI-2 differ from prior to time t2.

Due to the base station 10 sending an identifier of an emergency system information message in this manner, the UE 30 can be informed of a timing at which the emergency system information message is to be broadcast based on an identifier specified in the paging message and scheduling information of system information messages described in previously received SI-1, and can receive the emergency system information message.

Moreover, when the same emergency paging message is to be received a number of times, the UE 30 may be configured so as to either receive a system information message specified in the paging message every time the paging message is received, or to determine that the system information message to be urgently broadcast is the same and only receive, a predetermined number of times (for example, once), a system information message with the same identifier as the system information message to be urgently broadcast over a given period of time (for example, one Modification Period or for 10 seconds).

When terminating a broadcast of an emergency system information message, the base station 10 restores the emergency paging message to a normal-time paging message. In the example illustrated in FIG. 6B, the original paging message is restored at time t3. Subsequently, the broadcast of the system information message of the system information to be urgently broadcast is suspended and the original system information message is broadcast to the UE 30.

Moreover, when an urgent broadcast of a system information message is to be continuously performed, the base station 10 may continuously broadcast a paging message including the identifier of the system information message as long as the system information message is being broadcast.

In addition, when the same message is continuously broadcast as a system information message to be urgently broadcast, the base station 10 may transmit a emergency paging message (refer to FIG. 5C) during a first Modification Period (first period), transmit a paging message having both an Emergency Flag and a modification flag turned on during a next Modification Period (second period), and during a next or a subsequent Modification Period (third period), include scheduling information including emergency system information in SI-1 and restore to a normal-time paging message. Accordingly, the base station 10 is no longer required to broadcast emergency paging messages with the same content over a long period of time and the UE 30 no longer receives system information messages with the same content over and over again. Moreover, a paging message can be configured such that an Emergency Flag is set subordinate to a modification flag. Examples thereof are illustrated in FIGS. 5D to 5F. FIG. 5D illustrates a normal-time paging message, FIG. 5E illustrates a modification paging message, and FIG. 5F illustrates an emergency paging message. In other words, the Emergency Flag is included only when the modification flag is turned on. As operations in this case, while a UE that supports Emergency Flags immediately reads broadcast information using an SI identifier, a UE that does not support Emergency Flags treats the Emergency Flag as a normal modification flag and starts reading broadcast information from the top of the next Modification period.

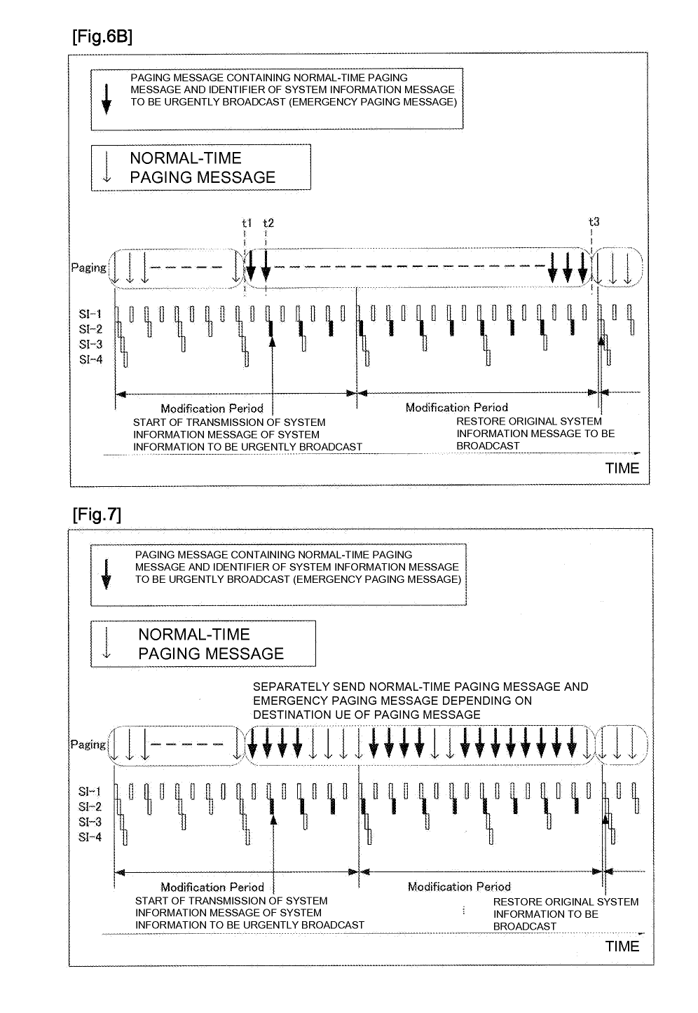

FIG. 7 is an explanatory diagram illustrating another broadcast method of paging messages according to the present embodiment. As illustrated in FIG. 7, the base station 10 may broadcast an emergency paging message only to a UE 30 that is an object of a system information message to be urgently broadcast, and broadcast a normal-time paging message to a UE 30 that is not an object. Since the timing at which the UE 30 receives a paging message is determined by a UE-identity, an emergency paging message may be sent only to an object UE 30.

According to the configuration described above, the base station 10 can arrange an emergency system information message to be received only by a broadcast object UE 30. In addition, since a UE 30 that is not an object of emergency system information messages does not realize that a modification has been made to the broadcast of system information messages, the UE 30 can keep operating without being affected and can also conserve power consumption.

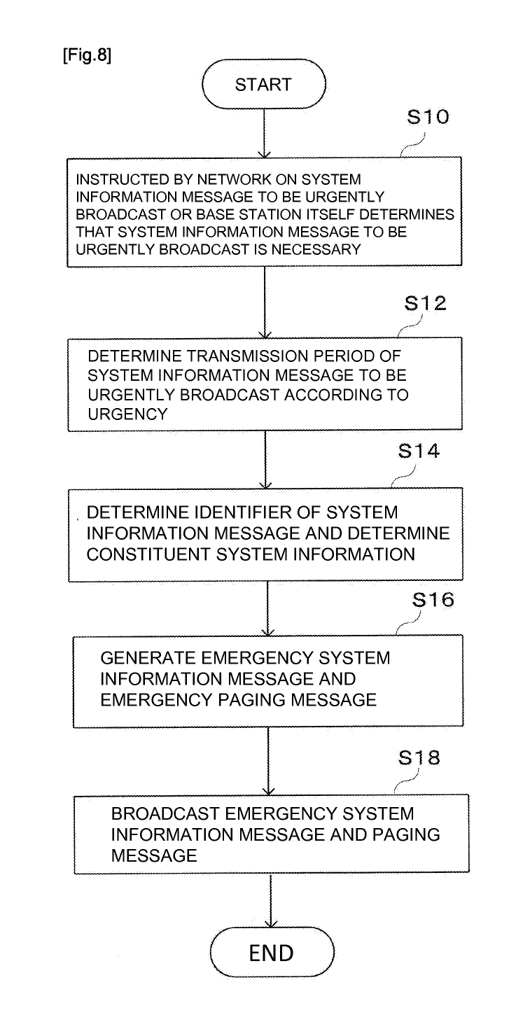

FIG. 8 is a diagram illustrating an operation example of the base station 10 when broadcasting emergency system information according to the present embodiment. The base station 10 is either indicated by the network of system information to be urgently broadcast or determines system information that needs to be urgently broadcast (S10). Depending on an urgency of an emergency system information message, the base station 10 determines a period at which the system information message is to be broadcast (S12). For example, when system information has a high degree of urgency, a broadcast period of the system information message may be shortened so as to provide the UE 30 with an opportunity to receive the system information message sooner, and when a system information message has a low degree of urgency, a broadcast period of the system information message may be extended so as to avoid affecting system information messages that are currently being broadcast.

At this point, the base station 10 may determine a period from system information messages that are currently being broadcast or a method may be determined in advance which enables the UE 30 to predict a period from scheduling information of system information messages that are currently being broadcast. In this case, a function may be provided where, when the same identifier as a currently broadcast system information message is not used, a system information message is newly generated. Subsequently, the base station 10 generates a system information message to be sent according to the determined period and configuration.

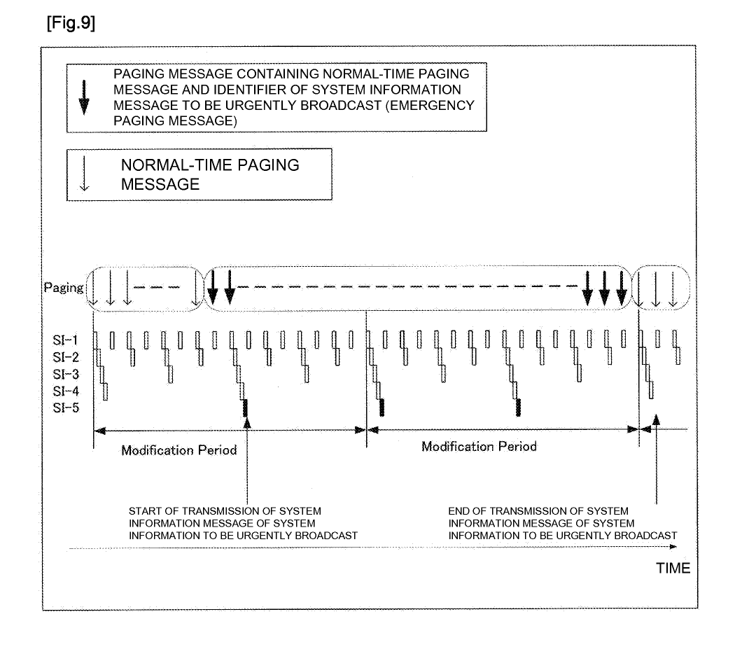

For example, as illustrated in FIG. 9, when SI-1 to SI-4 have already been sent, the same broadcast period as SI-4 and a broadcast timing immediately following SI-4 may be adopted. In addition, SI-5 may be adopted as the identifier of the system information message in order to imply that the timing is immediately subsequent to SI-4. When a method is adopted that enables a broadcast period to be predicted from a schedule of system information messages that are currently being broadcast, a period may be used that is twice as long as the longest broadcast period among the system information messages that are currently being broadcast or another broadcast period may be used. In this case, a UE that does not support a broadcast of an emergency system information message remains unaware that an emergency system information message is broadcast and is therefore unaffected.

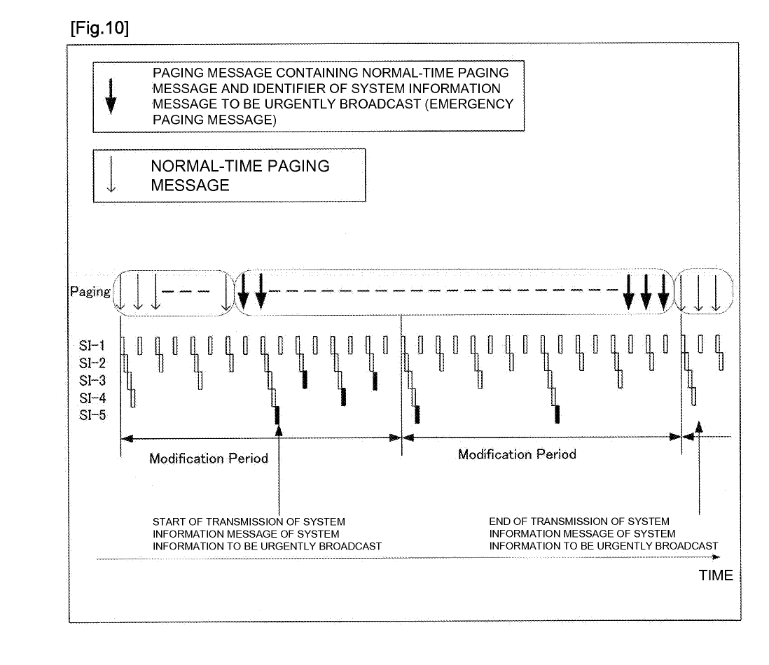

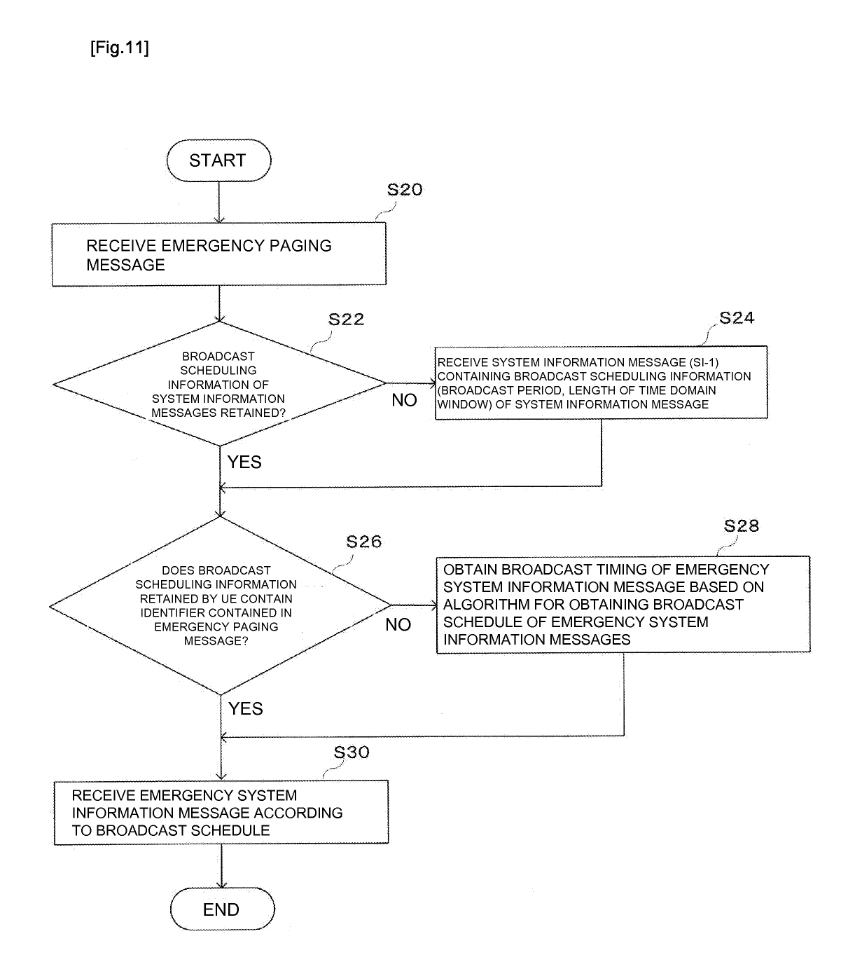

In addition, the base station 10 may include a broadcast period of an emergency system information message in a paging message in addition to an identifier of the emergency system information message. Such an arrangement enables the UE 30 to use scheduling information (broadcast period and length of time domain window) of system information messages that are currently being broadcast to be informed of a broadcast timing and a broadcast period of a system information message to be urgently broadcast and to receive the system information message to be urgently broadcast. Furthermore, when system information has a low degree of urgency, an emergency system information message can be broadcast without affecting system information messages that are currently being broadcast. The broadcast period to be adopted at this point may either be longer or shorter than a maximum broadcast period that is currently being broadcast. In other words, when a period longer than SI-4 that is the maximum broadcast period illustrated in FIG. 9 is specified, an operation such as illustrated in FIG. 9 is to be performed. Conversely, when a period shorter than SI-4 that is the maximum broadcast period illustrated in FIG. 9 is specified, a period shorter than SI-4 may be set as illustrated in FIG. 10. FIG. 10 illustrates a case where the same period as SI-2 is specified. In this case, newly added SI is transmitted immediately after SI-4 in a period where SI-2, SI-3, and SI-4 are sent, immediately after SI-2 in a period where only SI-2 is sent, and immediately after SI-3 in a period where SI-2 and SI-3 are sent.

In addition, when there is a large volume of information to be newly transmitted, the information may conceivably be transmitted using two SI units. For example, when SI-2 and SI-3 are transmitted at the same broadcast period, an indication can be issued so that both SI-2 and SI-3 are used in a paging message to transmit new broadcast information. Accordingly, a total amount of time of the time needed to transmit SI-2 and the time needed to transmit SI-3 can be used to transmit the new message.

When a broadcast period of a system information message to be urgently broadcast is determined, the base station 10 determines an identifier of the system information message and determines a configuration of a system information message to be generated (S14). For example, when using the same identifier as a system information message currently being broadcast, the entire system information message may be overwritten (refer to FIG. 4A), the system information message may be partially overwritten (refer to FIG. 4B), or the system information message may be supplemented (refer to FIG. 4C). In this manner, a system information message can be generated according to a length of a time domain window. When a time domain window has sufficient length, supplementing an existing system information message enables an emergency system information message to be transmitted in a short period without affecting broadcast of conventional system information messages. Furthermore, in a case where a UE that does not support emergency system information messages is provided with a function for discarding an SIB not supported by the UE, an emergency system information message can be sent without affecting the UE whatsoever.

Subsequently, the base station 10 generates a paging message (emergency paging message) including an identifier of the system information message to be urgently broadcast in accordance with the urgency (S16). The base station 10 then broadcasts the system information message and the paging message to the UE 30 (S18).

FIG. 11 is a diagram illustrating an operation example of the UE 30 when receiving an emergency system information message according to the present embodiment. The UE 30 receives a paging message (emergency paging message) including an identifier of an emergency system information message transmitted from the base station 10 (S20). The UE 30 having received the emergency paging message confirms whether scheduling information of system information messages is stored (S22). If scheduling information is not stored (“no” in S22), the UE 30 receives a system information message (SI-1) including scheduling information of system information messages (S24).

When the UE 30 stores scheduling information of system information messages (“yes” in S22) or after receiving a system information message (S24), the UE 30 determines whether or not the identifier of the system information message included in the emergency paging message is included in the already-stored scheduling information of system information messages (S26).

When the identifier of the system information message included in the emergency paging message is not included in the scheduling information of system information messages (“no” in S26), the UE 30 obtains a broadcast timing of the emergency system information message based on the stored scheduling information of system information messages using an algorithm for calculating a schedule of emergency system information messages stored in advance (S28).

As a specific calculation method, for example, a method may be adopted in which a system information message not described in the schedule is transmitted at the same period as a schedule of a system information message with a last identifier described in the already-stored schedule of system information messages and at a broadcast timing that is immediately after the system information message with the last identifier is sent, or a method may be adopted in which a system information message not described in the schedule is transmitted at twice the period of the schedule of a system information message with a last identifier described in stored scheduling information of system information messages and at a broadcast timing that is immediately after the system information message with the last identifier is sent.

While an example has been described where the UE 30 stores, in advance, an algorithm for obtaining a schedule of emergency system information messages, a schedule of an emergency system information message may alternatively be notified from the base station 10 to the UE 30. For example, the base station 10 includes a broadcast period of an emergency system information message in an emergency paging message in addition to an identifier (SI identifier) of the emergency system information message. The UE 30 may receive an emergency system information message based on the broadcast period and a broadcast timing that is immediately after the system information message with the last identifier among already-stored scheduling information of system information messages.

The UE 30 receives an emergency system information message based on the identifier of the system information message included in the emergency paging message and the already-received schedule of system information messages (S30).

Moreover, the base station 10 may be provided with a function that broadcasts an emergency paging message including a broadcast period in addition to an identifier of an emergency system information message. In addition, the UE 30 may be provided with a function where, when an identifier and a broadcast period of an emergency system information message is included in an emergency paging message, the system information message is determined to be broadcast at the broadcast period included in the paging message and a broadcast timing is to be determined from the identifier of the system information message as described above.

Moreover, in order to enable UE-side diversity reception of broadcast information, an interval referred to as an SI-window constituted by a several subframes is provided to system information other than MIB and SI-1 and the UE is to perform synthesis within the SI-window. Boxes for transmitting SI2, SI3, and SI4 illustrated in FIG. 6 respectively constitute SI-windows. The length of the SI-window is arranged so as to be variable depending on the network. In addition, not all subframes of an SI-window are usable for transmitting SI2, SI3, and the like, and a limitation exists in that transmission is disabled with subframes (MBSFN (Multicast Broadcast Single Frequency Network) subframe) using a different transmission method for multicast, subframes for uplink transmission in a TDD (Time division duplex), and subframes where SI-1 is transmitted. Since emergency broadcast information is conceivably sent on a preferential basis, transmission of emergency information may conceivably take place while ignoring all of or a part of the limitations described above.

With the base station 10 according to the first embodiment, since a broadcast timing of a system information message to be urgently broadcast is informed to the UE 30 by including an identifier of the system information message to be urgently broadcast in an emergency paging message, an emergency message can be broadcast promptly without changing the configuration of SI-1. In addition, since SI-1 is not modified within a Modification Period, a UE that does not support emergency message broadcast is less likely to be affected. Needless consumption of radio resources (frequency bands) and needless power consumption that had been occurring when a system information message to be urgently broadcast is not sent can now be suppressed.

Since the base station 10 according to the first embodiment performs broadcast scheduling of a system information message to be urgently broadcast according to the urgency of system information to be urgently broadcast and determines which system information message to be used from a several system information messages with different periods according to the urgency, an emergency message can be broadcast at a short time interval when the degree of urgency is high and broadcasting can be performed without affecting the broadcast of other system information messages when the degree of urgency is low. In addition, since only radio resources in accordance with urgency are used, needless consumption of radio resources and needless power consumption can now be suppressed.

Since the UE 30 according to the first embodiment is indicated by an emergency paging message of an identifier of a system information message to be urgently broadcast, the UE 30 can receive only a system information message that needs to be received. Consequently, needless power consumption can be suppressed.

Since a system information broadcast method according to the first embodiment uses a paging message to broadcast an identifier of a system information message to be urgently broadcast, not only an ETWS message but any kind of message can be urgently broadcast.

### Second Embodiment

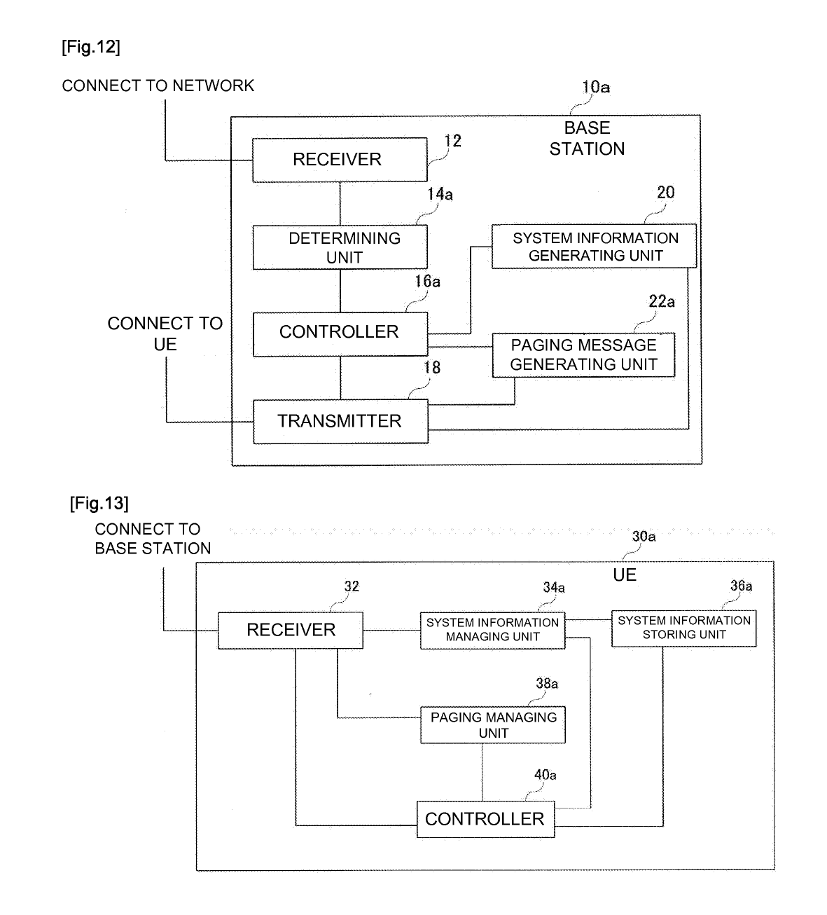

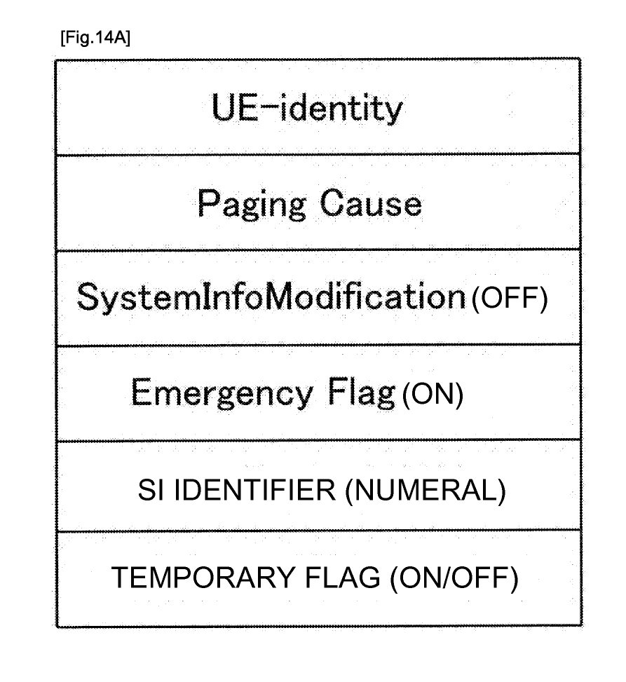

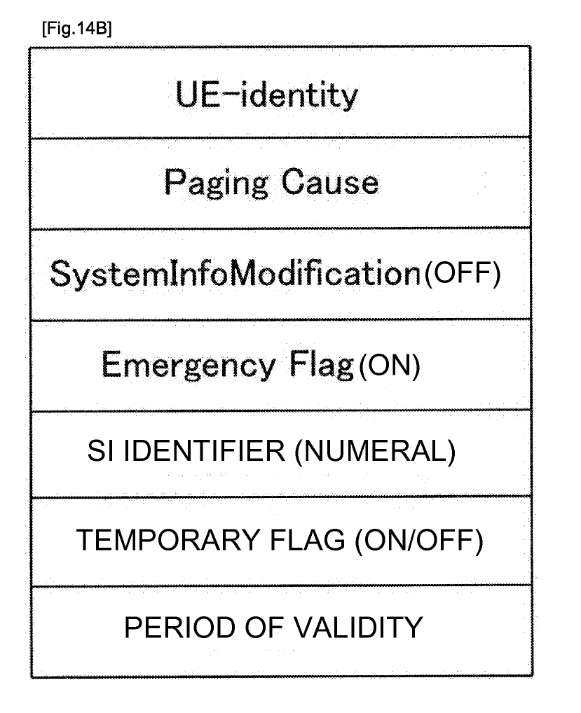

A second embodiment of the present invention will be described with reference to FIGS. 12 to 18. FIG. 12 is a diagram illustrating a configuration of a base station 10a according to the second embodiment, and FIG. 13 is a diagram illustrating a configuration of a UE 30a according to the second embodiment. While basic configurations of the base station 10a and the UE 30a according to the second embodiment are the same as the configurations of the base station 10 and the UE 30 according to the first embodiment, differences exist in contents of processing of a part of the components. Hereinafter, a description will be given with a focus on differences with the first embodiment. Moreover, unless particular reference is made to the contrary, components and operations according to the second embodiment are the same as those according to the first embodiment.

As illustrated in FIG. 12, the base station 10a comprises a receiver 12, a determining unit 14a, a controller 16a, a transmitter 18, a system information generating unit 20, and a paging message generating unit 22a.

The determining unit 14a analyzes a paging message, an ETWS message, system information, or the like inputted from the receiver 12, and in the case of an ETWS message or the like that must be urgently broadcast to the UE 30a, the determining unit 14 determines an urgency of system information thereof. In addition, when there is system information that the base station 10a itself has determined should be urgently broadcast (for example, access class control) besides information inputted from the receiver 12, the determining unit 14a determines an urgency of such system information.

When an urgency is determined, the determining unit 14a outputs a determination result of urgency and emergency system information to the controller 16a. When an urgency is not determined, the determining unit 14a outputs the inputted information as-is to the controller 16a. In addition, when a notification to the effect that information inputted from the receiver 12 is temporary information (in other words, a notification to the effect that the information is valid for a predetermined period of time), a period of validity of the information, or the like is sent together with the information inputted from the receiver 12, the determining unit 14a outputs the notification to the effect that the information is temporary information or the information regarding the period of validity together with the information to be outputted to the controller 16a.

When emergency system information and a determination result of urgency thereof are inputted, the controller 16a determines a broadcast period of an emergency system information message based on the information and scheduling information of system information messages currently being broadcast. Moreover, the method of determining a broadcast period of the emergency system information message is the same as in the first embodiment. In addition, the controller 16a determines a configuration of the system information message to be generated in the same manner as in the first embodiment.

The controller 16a indicates a configuration of an emergency system information message, constituent system information, an identifier of a system information message in which an emergency message is described, and a broadcast timing to the system information generating unit 20. Upon determining a configuration of an emergency system information message, a UE 30a to receive the broadcast, and a broadcast timing, the controller 16a determines a broadcast timing of a paging message. Moreover, contents of paging messages during normal time and during modification of normal system information are the same as in the first embodiment (refer to FIGS. 5A and 5B).

FIG. 14A is a diagram illustrating an example of a paging message used during a modification of emergency system information according to the second embodiment. As illustrated in FIG. 14A, an emergency paging message comprises a temporary flag in addition to a UE identifier (UE-identity), a Paging Cause, a modification flag (SystemInfoModification) (off), an Emergency Flag (on), and an SI identifier. A temporary flag is a flag indicating whether or not an emergency system information message is temporary system information with respect to the UE 30a. Besides the temporary flag, the configuration is the same as that of a paging message according to the first embodiment. Moreover, as illustrated in FIG. 14B, information regarding a period of validity may be included in the paging message as information indicating a time limit of the use of system information in the emergency message by the UE 30a.

When the controller 16a is notified by the network that system information is temporarily valid with respect to the UE 30a or when the controller 16a determines that emergency system information is temporarily valid with respect to the UE 30a, the controller 16a outputs, to the paging message generating unit 22a, the fact that the emergency system information message is temporarily valid, a broadcast timing of the paging message, information necessary for generating a paging message, and an identifier of the emergency system information message. Moreover, when a paging message is inputted to the controller 16a, the controller 16a outputs the inputted paging message to the paging message generating unit 22a.

The controller 16a outputs, to the transmitter 18, an identifier of a system information message, scheduling information (for example, a broadcast period, a length of a time domain window, or a broadcast timing) of the system information message, scheduling information of a paging message, and the fact that system information is temporarily valid. When the emergency system information is not temporary information, the controller 16a performs the same operations as in the first embodiment.

In addition, when the controller 16a is notified by the network of a modification of normal system information or when the base station 10a determines that a modification of normal system information is necessary, the controller 16a performs the same operations as in the first embodiment. Furthermore, when system information is not modified, the controller 16a performs the same operations as in the first embodiment.

Moreover, while information regarding a system information message is individually outputted from the controller 16a to the system information generating unit 20 and the paging message generating unit 22a in FIG. 12, the controller 16a may alternatively output whether or not system information is temporary information to the system information generating unit 20, and an identifier of the system information message and whether or not system information is temporary information may be outputted from the system information generating unit 20 to the paging message generating unit 22a.

The system information generating unit 20 performs the same operations as the system information generating unit 20 described in the first embodiment.

When the paging message generating unit 22a receives an input from the controller 16a to the effect that system information is temporary information, the paging message generating unit 22a generates a paging message including a flag indicating that the system information message is temporary. Other operations of the paging message generating unit 22a are the same as those according to the first embodiment.

Next, a configuration of the UE 30a according to the second embodiment will be described with reference to FIG. 13. As illustrated in FIG. 13, the UE 30a comprises a receiver 32, a system information managing unit 34a, a system information storing unit 36a, a paging managing unit 38a, and a controller 40a.

The system information managing unit 34a analyzes system information inputted from the receiver 32 and outputs system information to the system information storing unit 36a. The system information managing unit 34a performs processing based on system information stored in the system information storing unit 36a. For example, when it is determined that the period of validity of system information has expired and that system information needs to be updated, the system information managing unit 34a indicates the controller 40a to receive the system information.

Moreover, when there is a request from the controller 40a for acquiring system information stored in the system information storing unit 36a, the system information managing unit 34a may acquire the system information from the system information storing unit 36a and output the system information to the controller 40a. In addition, the system information managing unit 34a may be provided with a function where, when there is a request from the controller 40a for discarding system information stored in the system information storing unit 36a, the system information managing unit 34a discards the system information from the system information storing unit 36a.

Furthermore, upon receiving a notification from the controller 40a to the effect that system information is temporary, when storing the system information in the system information storing unit 36a, the system information managing unit 34a temporarily stores the original system information in a different storage area (for example, a different space in a memory). When a point in time notified by the controller 40a or a point in time determined in advance (for example, a given period of time or the end of a Modification Period) arrives, the system information managing unit 34a discards the temporary system information stored in the system information storing unit 36a and restores the original system information.

The system information storing unit 36a is constituted by a memory or the like, and stores system information inputted from the system information managing unit 34a and outputs necessary information to the system information managing unit 34a or the controller 40a. In addition, in response to an indication from the system information managing unit 34a, the system information storing unit 36a temporarily stores system information in a different storage area (for example, a different space in a memory), discards system information, or restores original system information.

The paging managing unit 38a analyzes a paging message inputted from the receiver 32. When an identifier of an emergency system information message is included in the paging message, the paging managing unit 38a outputs the identifier of the emergency system information message to the controller 40a and indicates the controller 40a to receive the emergency system information message. In addition, when a notification of a modification to a normal system information message is included, the paging managing unit 38a notifies the controller 40a as such. Furthermore, when a flag indicating that system information is temporary is included in a paging message that indicates reception of a system information message, the paging managing unit 38a notifies the controller 40a to that effect.

The controller 40a outputs, to the receiver 32, scheduling information (a broadcast period, a length of a time domain window, or a broadcast timing) of a paging message or a system information message that needs to be received based on contents of an indication from the paging managing unit 38a or the system information managing unit 34a, and indicates the receiver 32 to receive the message. At this point, if information in the system information storing unit 36a is required, the controller 40a makes a request for necessary information to the system information managing unit 34a or the system information storing unit 36a and acquires the necessary information. When it is determined that system information must be discarded, the controller 40a indicates the system information managing unit 34a or the system information storing unit 36a to discard the system information.

Upon being informed that the system information that the controller 40a had been indicated to receive by the paging managing unit 38a is temporary information, the controller 40a delivers the information to the system information managing unit 34a. Moreover, in doing so, information regarding a retention period (for example, a given period of time or the end of a Modification Period) may also be delivered.

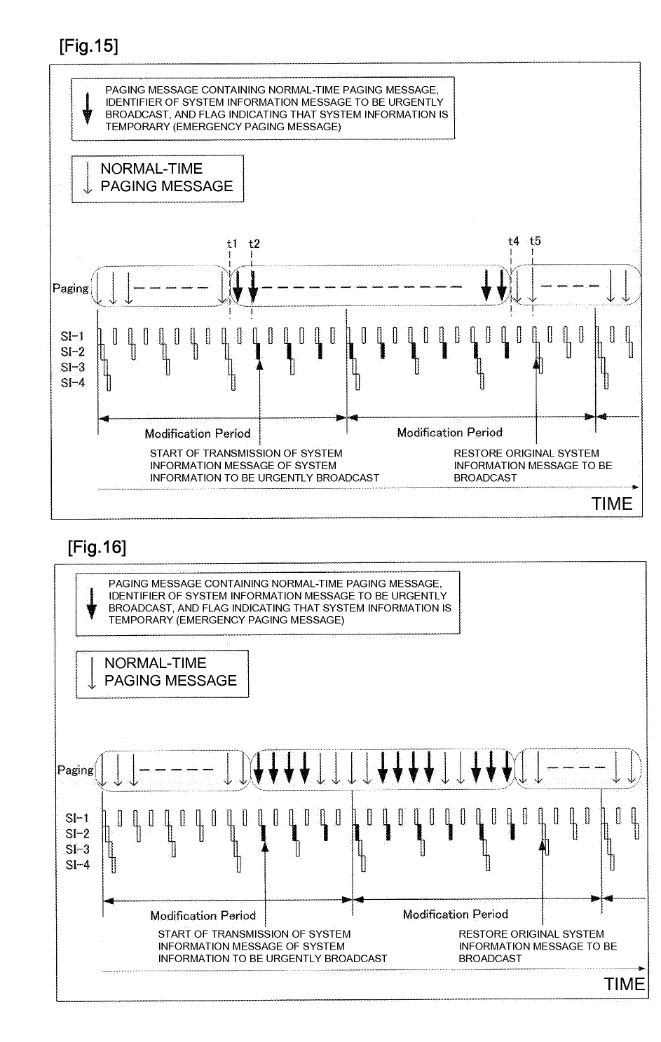

A method where the base station 10a urgently broadcasts system information to the UE 30a in the wireless communication system comprising the base station 10a and the UE 30a respectively configured as described above will now be described with reference to FIGS. 15 to 18.

FIG. 15 is an explanatory diagram of a paging message and a system information message to be broadcast by the base station 10a to the UE 30a according to the present embodiment. When the system information message to be urgently broadcast is a temporary system information message, the base station 10a broadcasts, to the UE 30a, a paging message (emergency paging message) that includes, in addition to contents of a normal-time paging message, an identifier of a system information message to be urgently broadcast and a flag which has been turned on and which indicates that the system information message is temporary system information. In the example illustrated in FIG. 15, an emergency paging message is transmitted from time t1.

After transmitting the emergency paging message, the base station 10a modifies the system information message that is being broadcast from the base station 10a to the UE 30a to a system information message to be urgently broadcast. In the example illustrated in FIG. 15, the system information message is modified from time t2. In the example illustrated in FIG. 15, the emergency system information message is transmitted using SI-2.

Due to the base station 10a sending an identifier of an emergency system information message and an emergency paging message with a flag which is turned on and which indicates that the emergency system information message is temporary system information in this manner, the UE 30a can be informed of a timing at which the emergency system information message is to be broadcast based on an identifier of a system information message specified in the emergency paging message and scheduling information of system information messages described in previously received SI-1, and receive the emergency system information message.

When terminating the broadcast of the emergency system information message, the base station 10a restores the paging message having the identifier of the system information message to be urgently broadcast and the flag which is turned on and which indicates a temporary system information message to a normal-time paging message. In the example illustrated in FIG. 15, the paging message is restored to the original paging message at time t4. Subsequently, the broadcast of the system information message of the system information to be urgently broadcast is suspended and the original system information message is broadcast to the UE 30a. In the example illustrated in FIG. 15, system information of SI-2 is restored from the emergency system information message to the original system information message at time t5.

In addition, after being informed that the emergency message is a temporary system information message and storing the same stored SIB to a different area in a storage area, the UE 30a saves the SIB included in the temporary system information message. Subsequently, when a period of time determined in advance (for example, 10 seconds, the end of a Modification Period) lapses, the UE 30a discards the SIB included in the temporary system information message and restores and uses the SIB saved in the different area in the storage area. Accordingly, the UE 30a is able to restore the original system information once a temporary period of time lapses even without receiving system information transmitted from time t5.

Moreover, as illustrated in FIG. 14B, when information regarding a period of validity is included in the emergency paging message, the SIB saved in the different area in the storage area is restored and used after the period of time indicated by the period of validity lapses.

At this point, when the same emergency paging message is to be received a number of times, the UE 30a may adopt a method where a system information message specified in the paging message is received every time the UE 30a receives the paging message, or the UE 30a may be configured so as to determine that the system information message to be urgently broadcast is the same and only receive, a predetermined number of times (for example, once), a system information message with the same identifier as the system information message to be urgently broadcast over a given period of time (for example, one Modification Period or 10 seconds).

Moreover, when an urgent broadcast of a system information message is to be continuously performed, the base station 10 may continuously broadcast a paging message including the identifier of the system information message as long as the system information message is being broadcast.

In addition, when the same message is continuously broadcast as a system information message to be urgently broadcast, the base station 10 may transmit a emergency paging message (refer to FIG. 5C) during a first Modification Period (first period), transmit a paging message having both an Emergency Flag and a modification flag turned on during a next Modification Period (second period), and during a next or a subsequent Modification Period (third period), include scheduling information including emergency system information in SI-1 and restore to a normal-time paging message. Accordingly, the base station 10 is no longer required to broadcast emergency paging messages with the same content over a long period of time and the UE 30 no longer receives system information messages with the same content over and over again.

FIG. 16 is an explanatory diagram of another broadcast method of a paging message according to the present embodiment. As illustrated in FIG. 16, the base station 10a may broadcast an emergency paging message only to a UE 30a that is an object of a system information message to be urgently broadcast, and broadcast a normal-time paging message to a UE 30a that is not an object. Since the timing at which a UE 30a receives a paging message is determined by a UE-identity, an emergency paging message may be sent only to an object UE 30a.

According to the configuration described above, the base station 10a can arrange a broadcast of an emergency system information message to be received only by an object UE 30a. In addition, since a UE 30a that is not an object of emergency system information messages does not realize that a modification has been made to the broadcast of system information messages, the UE 30a can keep operating without being affected and can also conserve power consumption.

Moreover, when a flag indicating a temporary system information message is absent, the operations of the base station 10a and the UE 30a are the same as those according to the first embodiment.

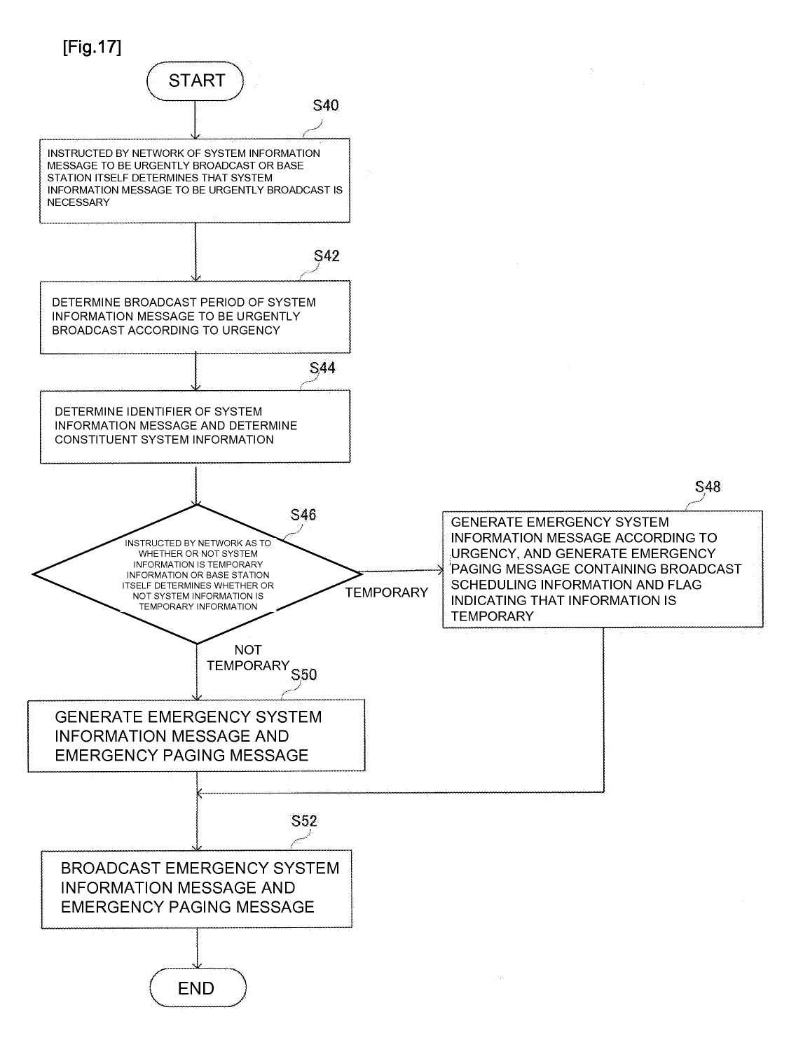

FIG. 17 illustrates an operation example of the base station 10a when broadcasting emergency system information according to the present embodiment. The base station 10a is either indicated by the network of system information to be urgently broadcast or determines system information that needs to be urgently broadcast (S40). Based on an urgency of the emergency system information, the base station 10a determines a period at which the system information is to be broadcast (S42). For example, when the system information has a high degree of urgency, a broadcast period of the system information may be shortened so as to provide a larger number of UEs 30a with an opportunity to receive the system information, and when the system information has a low degree of urgency, a broadcast period of the system information may be extended so as to avoid affecting system information messages that are currently being broadcast.

At this point, the base station 10a may determine a period from system information messages that are currently being broadcast or a method may be determined in advance which enables the UE 30a to predict a period from scheduling information of system information messages that are currently being broadcast. For example, when a method is adopted that enables a broadcast period to be predicted from a schedule of system information messages that are currently being broadcast, a period may be used that is any of a longest broadcast period among the system information messages that are currently being broadcast, a period that is twice as long as the longest broadcast period, and another broadcast period.

In addition, the base station 10a may include a broadcast period of an emergency system information message in a paging message in addition to an identifier of the emergency system information message. Such an arrangement enables a schedule of a system information message to be urgently broadcast to become known by using scheduling information of system information messages that are currently being broadcast (broadcast period and length of time domain window), and when system information has a low degree of urgency, an emergency system information message can be broadcast without affecting system information messages that are currently being broadcast.

When a period of a system information message to be urgently broadcast is determined, the base station 10a determines an identifier of the system information message and determines a configuration of a system information message to be generated (S44). For example, when using the same identifier as a system information message currently being broadcast, the entire system information message may be overwritten, the system information message may be partially overwritten, or the system information message may be supplemented.

When the same identifier as a currently broadcast system information message is not used, a system information message can be newly generated. Subsequently, the base station 10a generates a system information message to be sent according to the determined period and configuration.

The base station 10a is indicated from the network that the system information is temporary information, or the base station 10a itself determines whether or not the system information is temporary information (S46). When a determination of temporary information is made (“temporary” in S46), the base station 10a generates an emergency paging message that includes, in addition to contents of a normal-time paging message, an identifier of a system information message to be urgently broadcast in accordance with the urgency and a flag which is turned on and which indicates that the system information message is a temporary system information message (S48). When it is determined that the system information is not temporary (“not temporary” in S46), in the same manner as in the first embodiment, the base station 10a generates an emergency paging message that includes, in addition to contents of a normal-time paging message, an identifier of a system information message to be urgently broadcast in accordance with the urgency (S52).

After generating the emergency paging message, the base station 10a broadcasts the system information message and the paging message to the UE 30a (S52).

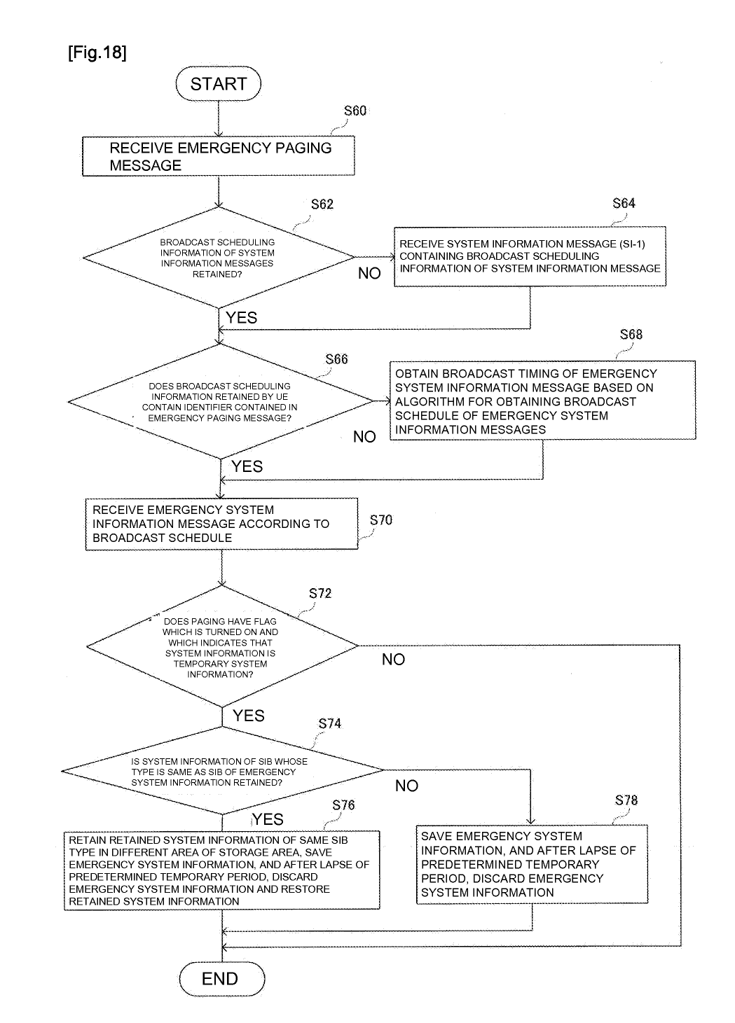

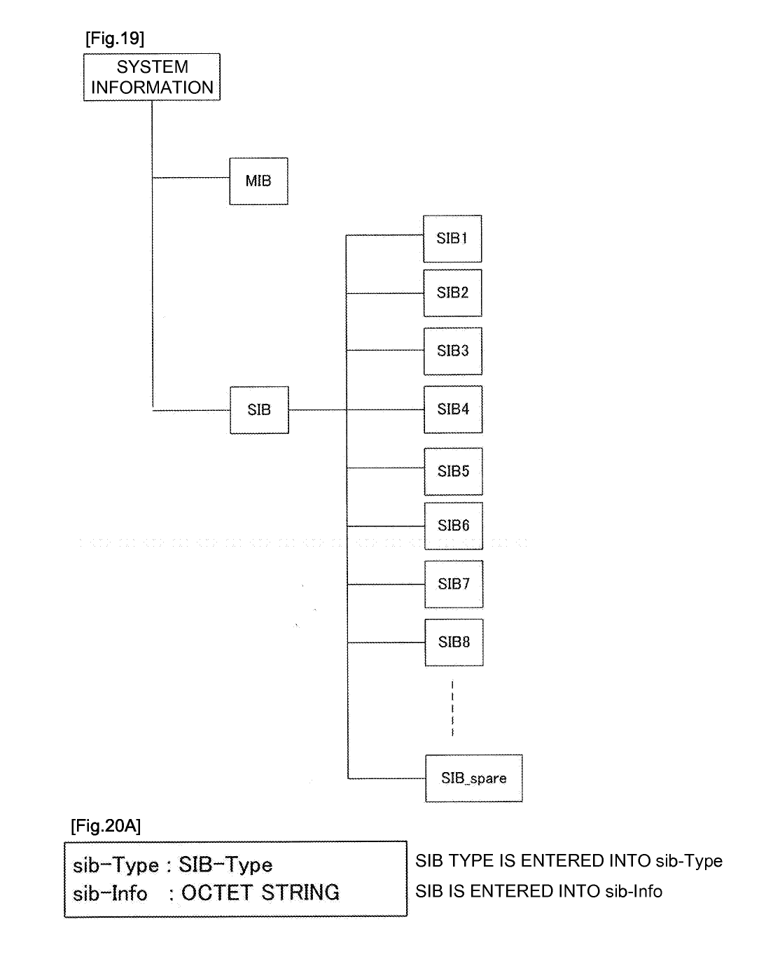

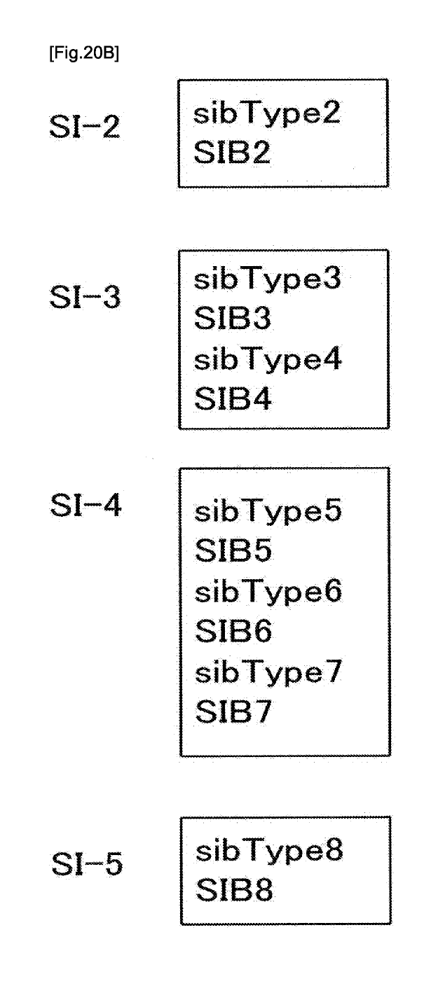

FIG. 18 is a diagram illustrating an operation example of the UE 30a when receiving emergency system information according to the present embodiment. The UE 30a receives an emergency paging message (S60). The UE 30a having received the emergency paging message determines whether or not scheduling information of system information messages is stored (S62). If scheduling information is not stored (“no” in S62), the UE 30a receives a system information message (SI-1) including scheduling information of system information messages (S64).

When the UE 30a stores scheduling information of system information messages (“yes” in S62) or upon receiving a system information message, the UE 30a determines whether or not the identifier of the emergency system information message is included in the already-stored scheduling information of system information messages (S66).

When the identifier of the emergency system information message is not described in the scheduling information of system information messages (“no” in S66), the UE 30a obtains a schedule of the emergency system information message based on the stored scheduling information of system information messages using an algorithm stored in advance for calculating a schedule of emergency system information messages (S68).

Specifically, for example, a method may be adopted in which a system information message not described in the scheduling information is transmitted at the same period as a schedule of system information messages with a last identifier described in the already-stored scheduling information of system information messages and at a broadcast timing that is immediately after the system information message with the last identifier is sent, or a method may be adopted in which a system information message not described in the scheduling information is transmitted at twice the period of the schedule of the system information message with the last identifier described in the stored scheduling information of system information messages and at a broadcast timing that is immediately after the system information message with the last identifier is sent.

The UE 30a receives an emergency system information message based on the identifier of the system information message included in the emergency paging message and the already-received schedule of system information messages (S70).

Next, the UE 30a determines whether or not a flag indicating that system information is temporary system information is turned on in the paging message (S72). When the flag indicating temporary system information is turned on (“yes” in S72), the UE 30a determines whether or not the same SIB as the SIB included in the emergency system information message is stored (S74). When an SIB of the same type is stored (“yes” in S74), the UE 30a saves the stored system information in a different area of a storage area and stores the emergency system information. Upon a lapse of a period of time determined in advance (for example, 10 seconds) or an arrival of a given point in time (for example, the end of a modification period), the UE 30a discards the emergency system information. The UE 30a restores the system information saved in the different area in the storage area to the original area in the storage area, and uses the system information (S76).

In addition, when the same SIB as the SIB included in the emergency system information message is not stored (“no” in S74), the UE 30a stores the system information, and upon a lapse of a period of time determined in advance (for example, 10 seconds) or an arrival of a given point in time (for example, the end of a modification period), the UE 30a discards the emergency system information (S78). When the flag indicating temporary system information is not turned on (“no” in S72), the UE 30a continues receiving the emergency system information message.

Since the UE 30a according to the second embodiment saves the original system information in a different area of a storage area when the system information message to be urgently broadcast by a paging message is temporary system information, a procedure of once again receiving system information can be omitted when restoring the system information and needless consumption of power can be suppressed.

Since the system information broadcast method according to the second embodiment enables a system information message to be urgently broadcast by the base station 10a to become a temporary system information message, the system information broadcast method is effective when modifying system information of the UE 30a only for a short period of time such as when setting access class control only for a short period of time.

Moreover, in the present embodiment, while an example has been described in which the base station 10a turns on a flag that indicates that system information is temporary system information in a paging message, a flag that indicates that a system information message is temporary system information may alternatively be turned on in the system information message itself.

In the present embodiment, while an example has been described in which a flag that indicates that a system information message is temporary system information is turned on in a paging message, when the system information message is temporary system information, a period of validity (for example, a given period of time, an end of a next Modification Period) may be included in the paging message in place of or together with the flag (refer to FIG. 14B).

In addition, in the present embodiment, while an example in which a temporary flag is included in a paging message has been described, a temporary flag may alternatively be included in a system information message. When information regarding a period of validity is used in place of a temporary flag as described above, information regarding a period of validity may be included in a system information message. Furthermore, when information regarding a period of validity is used together with a temporary flag, (1) the temporary flag is to be included in a paging message while the information regarding a period of validity is to be included in a system information message, (2) the information regarding a period of validity is to be included in the paging message while the temporary flag is to be included in the system information message, or (3) both the temporary flag and the information regarding a period of validity are to be included in the system information message.

Moreover, when an emergency system information message is handled as a modification of a normal system information message after broadcast of the emergency system information message, a value (hereinafter referred to as “value_tag”) that indicates an update of system information included in SI-1 is updated in order to inform the UE 30a of an update of the system information message. However, since the UE 30a need not receive SI-1 when receiving an emergency system information message, a value_tag is not received.

In consideration thereof, in a case where a value_tag is updated when urgently broadcasting a system information message, the base station 10a may be provided with either a function in which a value of the value_tag to be updated is included in a paging message, or a function in which a method of incrementing a current value_tag stored by the UE 30a by 1 is determined in advance and the base station 10a broadcasts the system information message to the UE 30a by turning on a flag that increments the value_tag by 1 in a paging message. Such a configuration prevents a discrepancy in values of value_tag from occurring between the base station 10a and the UE 30a when transmitting the emergency system information message. Therefore, the UE 30a can be prevented from performing a needless operation attributable to a discrepancy in values of value_tag of reading out all system information.

In addition, the UE 30a may be provided with a function where a value_tag of system information stored by the UE 30a itself is updated based on information acquired from a paging message. Furthermore, the base station 10a may be provided with a function where information regarding a value_tag is included in an SIB instead of in a paging message. Moreover, the UE 30a may be provided with a function where a value_tag of system information stored by the UE 30a itself is updated based on information regarding a value_tag included in an SIB. By adopting such arrangements, the UE 30a can be prevented from receiving the same system information.

While a base station and a UE of the present invention have been described in detail with respect to preferred embodiments thereof, it is to be distinctly understood that the present invention is not limited thereto.

In the embodiments described above, the UEs 30, 30a may be provided with a function where, upon receiving an SIB or a message that cannot be discriminated by the UEs themselves, the SIB or message is discarded, or a function where only a discriminable portion is discriminated and utilized.

In the embodiments described above, when broadcasting an emergency system information message, a paging message may include a broadcast period of the system information message in addition to an identifier of the system information message. In this case, the UEs 30, 30a determine whether or not the identifier of the system information message corresponds to scheduling information included in previously received SI-1. The UEs 30, 30a are provided with a function where, when the identifier of the system information message corresponds to scheduling information included in previously received SI-1, the UEs 30, 30a determine that a broadcast timing is the same but a broadcast period has been modified and receive the system information message. In addition, the UEs 30, 30a may be provided with a function where, when the identifier of the system information message does not correspond to scheduling information included in previously received SI-1, the UEs 30, 30a determine that a broadcast timing of the system information message is immediately after a system information message to be sent last among the stored schedule of system information messages and that a broadcast period is the broadcast period included in the paging message, and receive the system information message.

While an example in LTE has been cited in the embodiments described above, the present invention can also be applied to a UMTS (Universal Mobile Telecommunications System). Unlike in the case of LTE, in UMTS, an SIB schedule is included in an MIB and a SB (Scheduling Block) or only in an MIB, and the UEs 30, 30a can be informed of the SIB schedule from the MIB and SB or from the MIB.

In UMTS, a schedule for broadcasting SIBs is repeated every given number of frames (hereinafter referred to as “SIB_REP”). SIB_REP represents the number of frames where one frame is 10 milliseconds. From an SFN (System Frame Number) stored by the UEs 30, 30a and SIB_REP, the UEs 30, 30a can be informed of which frame number in SIB_REP is currently being broadcast. Specifically, modulo SIB_REP in the SFN is the frame number being broadcast among SIB_REP. A schedule of an SIB is indicated by a frame number (hereinafter referred to as “SIB_POS”) in SIB_REP. Therefore, by informing the UEs 30, 30a of the SIB_POS of the SIB to be urgently broadcast, the UEs 30, 30a can receive the SIB to be urgently broadcast from SIB_REP and SIB_POS.

In addition, when an SIB is broadcast in segments, the number of segments (hereinafter referred to as “SEG_COUNT”) is also included in scheduling information. Therefore, when an SIB is broadcast in segments, by informing the UEs 30, 30a of the number of segments, the UEs 30, 30a can receive the segmented SIB.

As described above, in UMTS, by using SIB_POS or SIB_POS and SEG_COUNT in place of the identifier of a system information message in LTE, the UEs 30, 30a can receive emergency broadcast information. Therefore, the base stations 10, 10a are provided with a function where, when urgently broadcasting system information to the UEs 30, 30a, a broadcast frame number (SIB_POS) of the SIB to be modified is included in Paging to be broadcast to the UEs 30, 30a.

The UEs 30, 30a are provided with a function for being informed of a schedule of system information to be urgently broadcast from SIB_POS included in the received Paging and SIB_REP stored in advance, and for receiving the system information to be urgently broadcast.

Moreover, states of UEs 30, 30a in UMTS differ from those in LTE, and there are UEs 30, 30a that do not receive Paging. However, in order to notify UEs 30, 30a in a state where Paging is not received of a modification to system information, the base stations 10, 10a broadcast a System Information Change Indication instead of Paging and the UEs 30, 30a receive the System Information Change Indication. Therefore, the base stations 10, 10a are provided with a function where, when urgently broadcasting system information to the UEs 30, 30a, SIB_POS of an SIB to be modified is included in Paging and System Information Change Indication to be broadcast to the UEs 30, 30a. The UEs 30, 30a are provided with a function for being informed of a schedule of system information to be urgently broadcast from SIB_POS included in the received Paging or System Information Change Indication and SIB_REP stored in advance, and for receiving the system information to be urgently broadcast.

Moreover, the base stations 10, 10a may be provided with a function for including SEG_COUNT in Paging to be broadcast when system information to be modified is urgently broadcast in segments. In addition, the base stations 10, 10a may be provided with a function for including SEG_COUNT in Paging and System Information Change Indication to be broadcast when system information to be modified is urgently broadcast in segments. Furthermore, the UEs 30, 30a may be provided with a function where, when SEG_POS2 and SEG_COUNT are included in the received Paging or System Information Change Indication, the segmented system information is received.

Moreover, the aforementioned base stations 10, 10a may be provided with a function where SIB_POS or SIB_POS and SEG_COUNT are included only in Paging or only in System Information Change Indication. In addition, the aforementioned base stations 10, 10a may be provided with a function where SIB_POS or SIB_POS and SEG_COUNT of system information to be urgently broadcast are broadcast using not only Paging and System Information Change Indication but also other messages that can be broadcast to the UEs 30, 30a. Furthermore, the aforementioned UEs 30, 30a may be provided with a function for receiving emergency broadcast information when indicated by not only Paging and System Information Change Indication but also other messages of the emergency broadcast information.

Moreover, in UMTS, a similar function as in LTE is provided when temporarily modifying system information. However, for UEs 30, 30a unable to receive paging, the same information as that added to paging may be added to system change information indication.

While it has been described above that scheduling information of other SIBs is included in SIB1 in the case of LTE and in an MIB in the case of UMTS, scheduling information may be included in an MIB or another SIB or scheduling information may be included in system information that performs the same role as MIB and SIB. In addition, while it has been arranged such that a broadcast period and a length of a time domain window are included in the case of LTE and SIB_REP and SIB_POS are included in the case of UMTS as scheduling information, scheduling information may be any information as long as a broadcast timing of system information can be informed.

In the present embodiment, while a system information message is arranged so as to comprise a type of a constituent SIB and the SIB itself, any configuration may be adopted as long as a UE can be informed of contents of the system information message upon reception thereof. While an identifier of a system information message or an identifier of a system information message together with a broadcast period are notified to a UE by broadcasting a paging message in the case of LTE and a paging message and a System Information Change Indication in the case of UMTS, other messages may alternatively be used as long as the message can be broadcast to the UE in the same manner as a paging message or a System Information Change Indication.

While there have been described what are at present considered to be the preferred embodiments of the present invention, it will be understood that various modifications may be made therein, and it is intended to cover in the appended claims all such modifications as fall within the true spirit and scope of the present invention.

### INDUSTRIAL APPLICABILITY

As described above, the present invention advantageously enables an emergency message to be promptly notified and is useful in situations where urgent broadcasting or modification of system information is required.

### REFERENCE SIGNS LIST

10, 10a base station
12 receiver
14, 14a determining unit
16, 16a controller
18 transmitter
20 system information generating unit
22, 22a paging message generating unit
30, 30a UE
32 receiver
34, 34a system information managing unit
36, 36a system information storing unit
38, 38a paging managing unit
40, 40a controller

1. A wireless communication base station that controls a wireless communication equipment using system information, the wireless communication base station comprising:
a system information generating unit that generates system information which includes a several system information messages and in which one system information message among the several system information messages includes a schedule of another system information message;
a paging message generating unit that generates a paging message including a modification flag that indicates whether or not the system information has been modified; and
a transmitter that transmits the system information generated by the system information generating unit and the paging message generated by the paging message generating unit, wherein
the system information generating unit generates system information including a system information message in which an emergency message is described, and
the paging message generating unit generates a paging message that further includes information indicating that the emergency message is present in the system information and an identifier that identifies a system information message in which the emergency message is described.

2. The wireless communication base station according to claim 1, wherein
broadcast periods of the several system information messages constituting the system information differ among system information messages, and
the system information generating unit determines in which system information message among the several system information messages the emergency message is to be described according to the urgency of the emergency message, and describes the emergency message in the determined system information message.

3. The wireless communication base station according to claim 1, wherein the paging message generating unit generates a paging message further comprising information indicating that the emergency message is temporarily valid.

4. The wireless communication base station according to claim 3, wherein the paging message generating unit generates a paging message further comprising information indicating a period of time in which the emergency message is valid.

5. The wireless communication base station according to claim 1, wherein
the transmitter transmits a paging message including information indicating the presence of the emergency message at a timing where a first group of wireless communication equipments receive paging, and transmits a paging message not including information indicating the presence of the emergency message at a timing where a second group of wireless communication equipments that differs from the first group of wireless communication equipments receive paging.

6. The wireless communication base station according to claim 1, wherein the paging message generating unit generates a paging message having an emergency flag indicating whether or not the emergency message is present, and indicates the presence of the emergency message by turning on the emergency flag.

7. The wireless communication base station according to claim 6, wherein when notifying the emergency message, the paging message generating unit generates a paging message with the modification flag turned off and the emergency flag turned on during a first period, generates a paging message with the modification flag turned on and the emergency flag turned on during a second period subsequent to the first period, and generates a paging message with the modification flag turned off and the emergency flag turned off during a third period subsequent to the second period.

8. The wireless communication base station according to claim 1, wherein the system information generating unit generates system information comprising an SI (System Information) message specified according to LTE (Long Term Evolution).

9. A wireless communication equipment that is controlled by system information transmitted from a wireless communication base station, the wireless communication equipment comprising:
a receiver that receives system information which includes a several system information messages and in which one system information message among the several system information messages includes a schedule of another system information message and that receives a paging message that includes an emergency flag that indicates whether or not an emergency message is present and, when the emergency message is present, an identifier that identifies a system information message in which the emergency message is described;
a paging managing unit that analyzes the paging message received by the receiver; and
a controller that obtains, when the paging managing unit determines that an emergency message is present, a broadcast timing of the system information message identified by the identifier included in the paging message based on the schedule, and that indicates the receiver to receive the system information message at the broadcast timing.

10. The wireless communication equipment according to claim 9, wherein
the paging managing unit analyzes the paging message to determine whether or not the emergency message is temporarily valid, and
when the emergency message is determined to be temporarily valid, the controller shelters the system information prior to the transmission of the emergency message.

11. The wireless communication equipment according to claim 10, wherein
the paging managing unit analyzes the paging message to obtain a temporary period of time in which the emergency message is valid, and
the controller reads out the sheltered system information upon the lapse of the period of time.

12. The wireless communication equipment according to claim 9, wherein the receiver receives system information comprising an SI (System Information) message specified according to LTE (Long Term Evolution).

13. A wireless communication system in which a wireless communication base station and a wireless communication equipment are connected, wherein the wireless communication base station comprises:
a system information generating unit that generates system information which includes a several system information messages and in which one system information message among the several system information messages includes a schedule of another system information message;
a paging message generating unit that generates a paging message including a modification flag that indicates whether or not the system information has been modified; and
a transmitter that transmits the system information generated by the system information generating unit and the paging message generated by the paging message generating unit,
the system information generating unit adapted to generate system information including a system information message in which an emergency message is described, and
the paging message generating unit adapted to generate a paging message that further includes information indicating that the emergency message is present in the system information and an identifier that identifies a system information message in which the emergency message is described,
the wireless communication equipment comprises:
a receiver that receives the system information and the paging message;
a paging managing unit that analyzes the paging message received by the receiver; and
a controller that obtains, when the paging managing unit determines that an emergency message is present, a broadcast timing of the system information message identified by the identifier included in the paging message based on the schedule, and that indicates the receiver to receive the system information message at the broadcast timing.

14. A method of a wireless communication base station notifying a wireless communication equipment of an emergency message, the emergency message notification method comprising the steps of:
the wireless communication base station generating system information which includes a several system information messages and in which one system information message among the several system information messages includes a schedule of another system information message;
the wireless communication base station generating a paging message including a modification flag that indicates whether or not the system information has been modified;
the wireless communication base station transmitting the system information; and
the wireless communication base station transmitting the paging message, wherein
in the step of generating system information, system information is generated which includes a system information message in which an emergency message is described, and
in the step of generating a paging message, a paging message is generated that further includes information indicating that the emergency message is present in the system information and an identifier that identifies a system information message in which the emergency message is described.

15. A method in which a wireless communication equipment receives an emergency message transmitted from a wireless communication base station, the emergency message reception method comprising the steps of:
the wireless communication equipment receiving system information which includes a several system information messages and in which one system information message among the several system information messages includes a schedule of another system information message;
the wireless communication equipment receiving a paging message that includes an emergency flag that indicates whether or not an emergency message is present and, when the emergency message is present, an identifier that identifies a system information message in which the emergency message is described;
the wireless communication equipment analyzing the received paging message; and
when it is determined based on the paging message that an emergency message is included in the system information, the wireless communication equipment obtaining a broadcast timing of the system information message identified by the identifier included in the paging message based on the schedule, and controlling so as to receive the system information message at the broadcast timing.
